(19) United States
(12) Patent Application Publication
(10) Pub. No.: US 2021/0192371 A1
(43) Pub. Date: Jun. 24, 2021

(54) COMPUTER-READABLE RECORDING MEDIUM, INFORMATION PROCESSING APPARATUS, AND DATA GENERATING METHOD

(71) Applicant: FUJITSU LIMITED, Kawasaki-shi (JP)

(72) Inventors: Shinichiro Tago, Shinagawa (JP); Kenichi KOBAYASHI, Kawasaki (JP); Hiyori Yoshikawa, Kawasaki (JP); Kenji KOBAYASHI, Kawasaki (JP); Masaru FUJI, Musashino (JP)

(73) Assignee: FUJITSU LIMITED, Kawasaki-shi (JP)

(21) Appl. No.: 17/122,621

(22) Filed: Dec. 15, 2020

(30) Foreign Application Priority Data
Dec. 20, 2019 (JP) 2019-230985

(51) Int. Cl. G06N 5/04; G06N 20/00

(52) U.S. Cl. CPC G06N 5/04; G06K 9/6232; G06N 20/00

(57) ABSTRACT

A shortest path searching unit 121 identifies a first group by a shortest path search conducted from a start point node in a forward direction within a first distance and identifies a second group by another shortest path search conducted from an end point node in a reverse direction within a second distance. A feature graph generating unit 122 generates, when sum of a distance of a first shortest path between the start point node and a first node included in the first group and a distance of a second shortest path between the end point node and a second node included in the second group is not more than a threshold obtained by adding a specific distance to a distance of a shortest path between the start point node and the end point node, a feature graph including the first shortest path and the second shortest path.

### CROSS-REFERENCE TO RELATED APPLICATION(S)

This application is based upon and claims the benefit of priority of the prior Japanese Patent Application No. 2019-230985, filed on Dec. 20, 2019, the entire contents of which are incorporated herein by reference.

### FIELD

The embodiment discussed herein is related to a data generating technology.

### BACKGROUND

There is a technology for estimating relationships between a plurality of pieces of information in a knowledge base. In this technology, a feature graph is constructed by, for example, defining relationships to be estimated from among the relationships present in the knowledge base, listing the relationships that are correct, and adding, regarding each of the listed relationships, paths each connecting a starting point and an end point and the peripheral information of the paths. Then, in this technology, a machine learning model is constructed by machine learning by using a set of combinations of the type (correct/incorrect) of the relationship and the feature graph as an input. Furthermore, in this technology, the relationship is estimated by constructing the feature graph in which the paths connecting the starting point and the end point whose relationships are desired to be estimated and the peripheral information of the paths are added and by inputting the feature graph to the machine learning model.

Here, in a construction method of the feature graph, the feature graph is constructed by listing all of the paths from the starting point to the end point within a (distance of the shortest path+α) (α: a natural number) and including all of the listed paths. FIG. 13 is a diagram illustrating a reference example of the construction method of the feature graph. In the upper part of FIG. 13, a knowledge base of proteins is represented. This is a case in which the relationship between a node a and a node b is desired to be estimated. The node a indicates the starting point and the node b indicates the end point. Regarding the relationship desired to be estimated in the knowledge base, a device that constructs the feature graph lists all of the paths connecting the starting point (the node a) and the end point (the node b). Then, from among the listed paths, the device lists all of the paths within the (distance of the shortest path+α). Then, the device constructs the feature graph constituted of all of the listed paths. The lower part of FIG. 13 indicates the constructed feature graph.

Related arts are disclosed in Japanese National Publication of International Patent Application No. 2016-538615, Japanese Laid-open Patent Publication No. 2014-81841, and Japanese Laid-open Patent Publication No. 2012-181765.

### SUMMARY

According to an aspect of an embodiment, a non-transitory computer-readable recording medium has stored therein instructions executable by one or more computer. The instructions includes one or instructions for identifying a first path group by a shortest path search conducted from a start point node in a forward direction within a first distance, the start point node being included in a plurality of nodes in a directed graph. The instructions includes one or instructions for identifying a second path group by another shortest path search conducted from an end point node in a reverse direction within a second distance, the end point node being included in the plurality of nodes. The instructions includes one or instructions for generating, when sum of a distance of a first shortest path between the start point node and a first node included in the first path group and a distance of a second shortest path between the end point node and a second node included in the second path group is not more than a threshold obtained by adding a specific distance to a distance of a shortest path between the start point node and the end point node, a feature graph including the first shortest path and the second shortest path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of an information processing apparatus according to an embodiment;

FIG. 2 is a diagram illustrating the outline of a generating process according to the embodiment;

FIG. 3 is a diagram illustrating a modification example of the outline of the generating process according to the embodiment;

FIG. 4 is a diagram illustrating an example of a data structure of a node list according to the embodiment;

FIG. 5 is a diagram illustrating an example of a data structure of an edge list according to the embodiment;

FIG. 6 is a diagram illustrating an example of a data structure of a starting point purpose table according to the embodiment;

FIG. 7 is a diagram illustrating an example of a data structure of an end point purpose table according to the embodiment;

FIG. 8 is a diagram illustrating an example of a variable table according to the embodiment;

FIG. 9A is a diagram (1) illustrating an example of the flow of a shortest path searching process according to the embodiment;

FIG. 9B is a diagram (2) illustrating an example of the flow of the shortest path searching process according to the embodiment;

FIG. 9C is a diagram (3) illustrating an example of the flow of the shortest path searching process according to the embodiment;

FIG. 9D is a diagram (4) illustrating an example of the flow of the shortest path searching process according to the embodiment;

FIG. 9E is a diagram (5) illustrating an example of the flow of the shortest path searching process according to the embodiment;

FIG. 9F is a diagram (6) illustrating an example of the flow of the shortest path searching process according to the embodiment;

FIG. 9G is a diagram (7) illustrating an example of the flow of the shortest path searching process according to the embodiment;

FIG. 9H is a diagram (8) illustrating an example of the flow of the shortest path searching process according to the embodiment;

FIG. 9I is a diagram (9) illustrating an example of the flow of the shortest path searching process according to the embodiment;

FIG. 9J is a diagram (10) illustrating an example of the flow of the shortest path searching process according to the embodiment;

FIG. 9K is a diagram (11) illustrating an example of the flow of the shortest path searching process according to the embodiment;

FIG. 9L is a diagram (12) illustrating an example of the flow of the shortest path searching process according to the embodiment;

FIG. 9M is a diagram (13) illustrating an example of the flow of the shortest path searching process according to the embodiment;

FIG. 9N is a diagram (14) illustrating an example of the flow of the shortest path searching process according to the embodiment;

FIG. 9O is a diagram (15) illustrating an example of the flow of the shortest path searching process according to the embodiment;

FIG. 9P is a diagram (16) illustrating an example of the flow of the shortest path searching process according to the embodiment;

FIG. 10A is a diagram (1) illustrating an example of the flow of a feature graph generating process according to the embodiment;

FIG. 10B is a diagram (2) illustrating an example of the flow of the feature graph generating process according to the embodiment;

FIG. 10C is a diagram (3) illustrating an example of the flow of the feature graph generating process according to the embodiment;

FIG. 10D is a diagram (4) illustrating an example of the flow of the feature graph generating process according to the embodiment;

FIG. 10E is a diagram (5) illustrating an example of the flow of the feature graph generating process according to the embodiment;

FIG. 10F is a diagram (6) illustrating an example of the flow of the feature graph generating process according to the embodiment;

FIG. 10G is a diagram (7) illustrating an example of the flow of the feature graph generating process according to the embodiment;

FIG. 10H is a diagram (8) illustrating an example of the flow of the feature graph generating process according to the embodiment;

FIG. 10I is a diagram (9) illustrating an example of the flow of the feature graph generating process according to the embodiment;

FIGS. 11A, 11B and 11C are flowcharts illustrating an example of the flow of the flow of the feature graph generating process according to the embodiment;

FIG. 12 is a diagram illustrating an example of a computer that executes a data generating program; and

FIG. 13 is a diagram illustrating a reference example of a construction method of a feature graph.

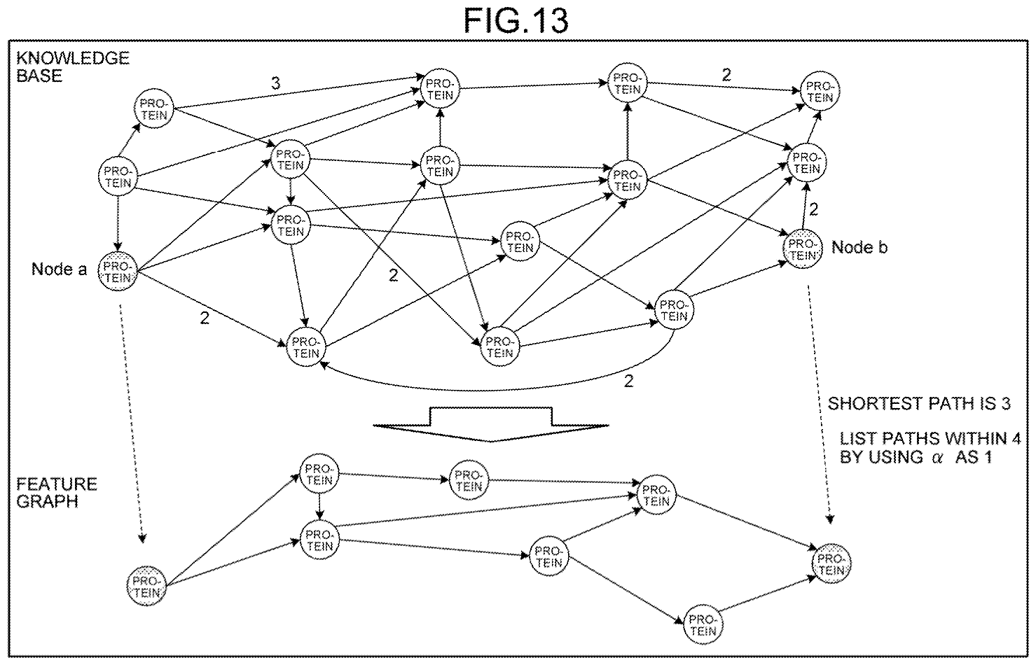

### DESCRIPTION OF EMBODIMENT

In the conventional construction method of the feature graph, there is a problem in that the calculation load for generating the feature graph from a knowledge base is high. Namely, in a reference example of the construction method of the feature graph, because all of the paths connecting the starting point and the end point whose relationships are desired to be estimated in a knowledge base are searched, a calculation load for the search becomes high.

Preferred embodiments of the present invention will be explained with reference to accompanying drawings. Furthermore, the present invention is not limited to the embodiments.

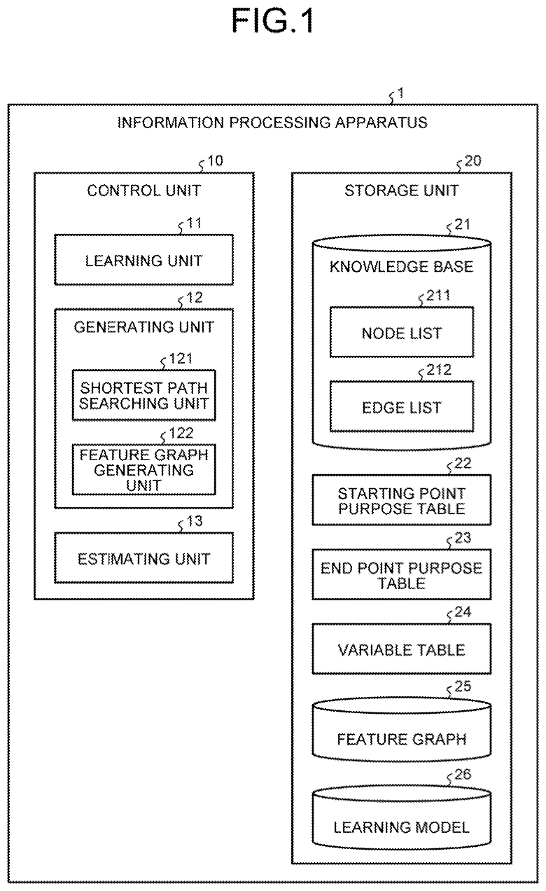

FIG. 1 is a functional block diagram illustrating a configuration of an information processing apparatus according to an embodiment. An information processing apparatus 1 generates a feature graph used to distinguish a relationship between a starting point node and an end point node given in a directed graph indicating a knowledge base as follows. The information processing apparatus conducts a shortest path search from each of the starting point node and the end point node within a predetermined distance and determines whether the sum of the shortest paths from the respective starting point node and the end point node is within the predetermined distance. Then, regarding the node in which the sum of the shortest paths is within the predetermined distance, the information processing apparatus adds a path obtained by adding up two paths of the shortest path from the starting point node and the shortest path from the end point node, and then generates a feature graph.

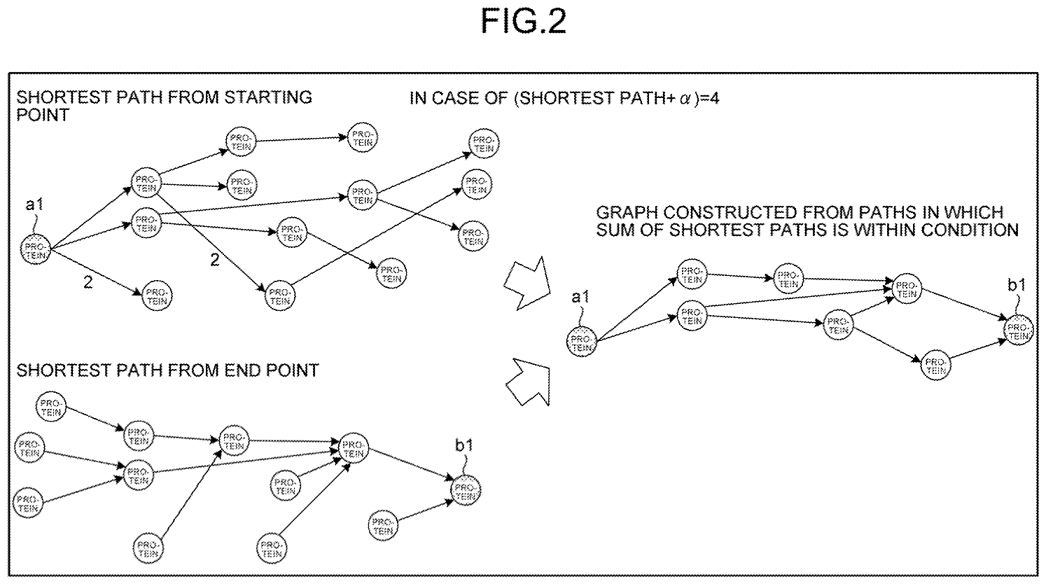

Outline of a generating process of the feature graph will be described with reference to FIG. 2. FIG. 2 is a diagram illustrating the outline of the generating process according to the embodiment. As illustrated in FIG. 2, regarding a directed graph indicating a knowledge base, a starting point node al and an end point node b1 whose relationship is desired to be estimated are indicated in gray. Furthermore, here, a knowledge base related to proteins is used as an example of the knowledge base.

The information processing apparatus generates a feature graph by searching for, as described below, a path that connects the starting point node al and the end point node b1 whose relationship is desired to be estimated and that has a distance within a (distance of the shortest path+α), and by adding the searched path. The information processing apparatus conducts a shortest path search from the starting point node al to the end point node b1 in the forward direction within a first distance. Furthermore, the information processing apparatus conducts a shortest path search from the end point node b1 to the starting point node al in the reverse direction within a second distance. Here, it is assumed that the first distance and the second distance is the (distance of the shortest path+α). It is assumed that the (distance of the shortest path+α) is, for example, “4”. The reason for searching for a path having the (distance of the shortest path+α) instead of searching for a path having a distance of the shortest path is that the path is made to pass, by giving an allowance of a, from the starting point node al to the end point node b1 without unexpectedly missing the feature between these nodes. The upper left of FIG. 2 indicates a first path group obtained from the result of the shortest path search conducted from the starting point node al in the forward direction. Namely, the first path group is the shortest path group within “4” from the starting point node al in the forward direction. The lower left of FIG. 2 indicates a second path group obtained from the result of the shortest path search conducted from the end point node b1 in the reverse direction. Namely, the second path group is the shortest path group within “4” from the end point node b1 in the reverse direction.

Then, regarding each node x included in both of the first path group and the second path group, the information processing apparatus calculates the sum of the distance of the first shortest path from the starting point node al to the node x and the distance of the second shortest path from the node x to the end point node b1. Then, the information processing apparatus adds, to the feature graph, the path that connects the first shortest path and the second shortest path of the node x and in which the calculated sum is less than or equal to the (distance of the shortest path+α). Here, the diagram on the right side indicates a feature graph generated from the paths in which the sum of the distances of the shortest paths is within the (distance of the shortest path+α), i.e., (“4”).

In this way, when generating the feature graph, the information processing apparatus can reduce an amount of calculation while ensuring the feature of the feature graph as compared with the conventional technique for constructing a feature graph by listing all of the paths from the starting point node al to the end point node b1 within the (distance of the shortest path+α). Namely, when the (distance of the shortest path+α) is “4”, with the conventional technique, an amount of calculation needed to generate a feature graph is “3⁴”. In contrast, with the technique using the information processing apparatus according to the embodiment, an amount of calculation needed to generate a feature graph is about “24” that indicates the number of edges that can be reached, and it is thus possible to reduce an amount of calculation while ensuring the feature of the feature graph.

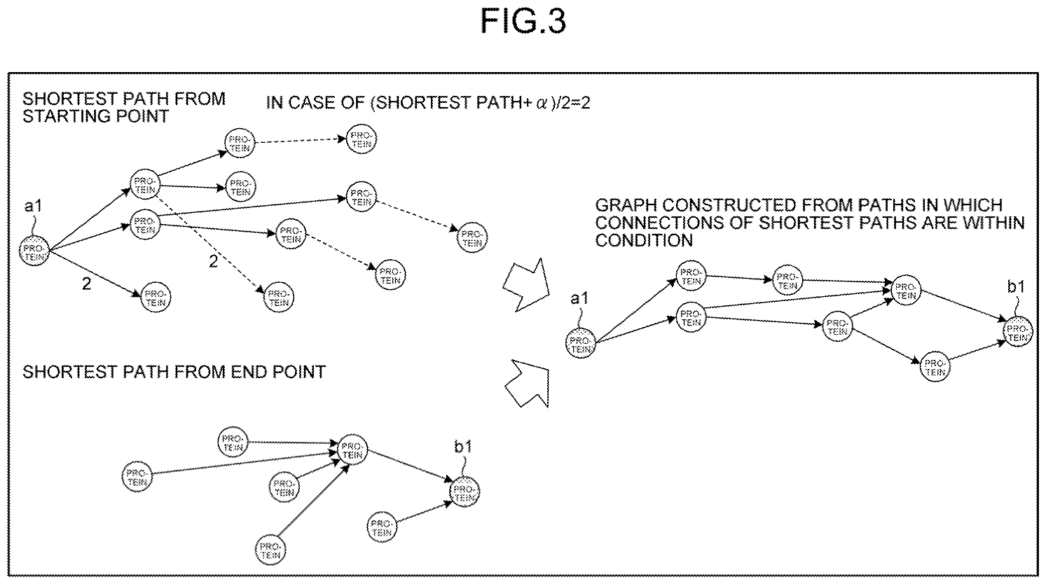

Furthermore, in FIG. 2, the information processing apparatus conducts a shortest path search from each of the starting point node and the end point node within the (distance of the shortest path+α); however, the embodiment is not limited to this. In FIG. 3, a description will be given of a case in which the information processing apparatus uses Dijkstra's algorithm and conducts a shortest path search from each of the starting point node and the end point node within the (distance of the shortest path+α)/2.

FIG. 3 is a diagram illustrating a modification example of the outline of the generating process according to the embodiment. In also the case illustrated in FIG. 3, similarly to the diagram illustrated in FIG. 2, regarding the directed graph indicating a knowledge base, the starting point node al and the end point node b1 are indicated in gray. Furthermore, here, a knowledge base related to proteins is used as an example of a knowledge base.

The information processing apparatus generates a feature graph by searching for, as described below, a path that connects the starting point node al and the end point node b1 whose relationship is desired to be estimated and that has the distance within the (distance of the shortest path+α) and by adding the searched path. The information processing apparatus conducts a shortest path search from the starting point node al to the end point node b1 in the forward direction within the first distance. Furthermore, the information processing apparatus conducts a shortest path search from the end point node b1 to the starting point node al in the reverse direction within the second distance. The shortest path search includes setting of a tentative distance of the shortest path of a node (hereinafter, referred to as a “neighboring node”) in the vicinity of the starting point node al or the end point node b1 adjacent to a node (hereinafter, referred to as an “adjacent node”). Here, it is assumed that the first distance and the second distance are the (distance of the shortest path+α)/2. It is assumed that the (distance of the shortest path+α)/2 is, for example, “2”. The upper left of FIG. 3 indicates the first path group obtained from the result of the shortest path search conducted from the starting point node al in the forward direction. Namely, the first path group is the shortest path group within “2” from the starting point node al in the forward direction. The lower left of FIG. 3 indicates the second path group obtained from the result of the shortest path search conducted from the end point node b1 in the reverse direction. Namely, the second path group is the shortest path group within “2” from the end point node b1 in the reverse direction. Then, the node pointed by the head of the arrow having the edge indicated by the dotted line is the adjacent node that is adjacent to the neighboring node and that is set as the tentative distance.

Then, regarding each of the nodes x included in the first path group and the second path group, the information processing apparatus calculates the sum of the distance of the first shortest path from the starting point node al to the node x and the distance of the second shortest path from the node x to the end point node b1. Then, the information processing apparatus adds, to the feature graph, the path that connects the first shortest path and the second shortest path of the node x and in which the calculated sum is less than or equal to the (distance of the shortest path+α). Here, the diagram on the right side indicates the feature graph generated from the paths in which the sum of the distances of the shortest paths is within the (distance of the shortest path+α), i.e., (“4”).

In this way, when generating the feature graph, the information processing apparatus can reduce an amount of calculation while ensuring the feature of the feature graph as compared with the conventional technique for constructing a feature graph by listing all of the paths from the starting point node al to the end point node b1 within the (distance of the shortest path+α). Furthermore, the information processing apparatus can further reduce the amount of calculation as compared with a case of conducting a shortest path search conducted from each of the starting point node and the end point node illustrated in FIG. 2 within the (distance of the shortest path+α). Namely, when the (distance of the shortest path+α) is “4”, with the technique performed by the information processing apparatus, an amount of calculation needed to generate a feature graph is about “17”, and it is thus possible to reduce amount of calculation while ensuring the feature of the feature graph.

The information processing apparatus 1 includes a control unit 10 and a storage unit 20.

The control unit 10 corresponds to an electronic circuit, such as a central processing unit (CPU). Furthermore, the control unit 10 includes an internal memory that is used to store therein control data and programs in which various kinds of processing procedure are prescribed, whereby the control unit 10 executes various kinds of processes. The control unit 10 includes a learning unit 11, a generating unit 12, and an estimating unit 13. Furthermore, the generating unit 12 is an example of a specifying unit and a generating unit.

The storage unit 20 is, for example, a semiconductor memory device, such as a RAM and a flash memory, or a storage device, such as a hard disk and an optical disk. The storage unit 20 includes a knowledge base 21, a starting point purpose table 22, an end point purpose table 23, a variable table 24, a feature graph 25, and a machine learning model 26.

The knowledge base 21 is a database in which knowledge is described based on a specific expression form. In the knowledge base 21, for example, knowledge can be described based on the directed graph. The knowledge base 21 includes a node list 211 and an edge list 212. Furthermore, the embodiment described below, a knowledge base related to proteins is used as an example of the knowledge base 21.

The node list 211 is a list for managing nodes used in the knowledge base 21. The edge list 212 is a list for managing edges that are between the nodes used in the knowledge base 21.

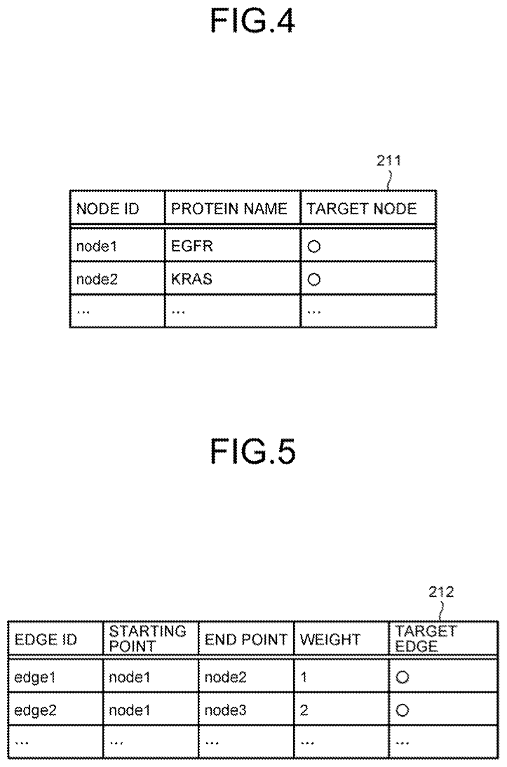

Here, a data structure of the node list 211 will be described with reference to. FIG. 4 is a diagram illustrating an example of the data structure of the node list according to the embodiment. As illustrated in FIG. 4, the node list 211 stores therein a node identification (ID), a protein name, and a target node in association with each other. The node ID indicates an identifier for identifying a node. The protein name indicates the name of a protein that is information indicated by a node. The target node indicates a node targeted for adding to the feature graph. In the item of the target node, as an example, “O” is set when a node is a target node to be added to the feature graph, whereas “X” is set when a node is not a target node that is not to be added to the feature graph. Furthermore, “X” may also be set as a default of the target node.

As an example, when the node ID is “node1”, “EGFR” is stored as the protein name and “O” is stored as the target node.

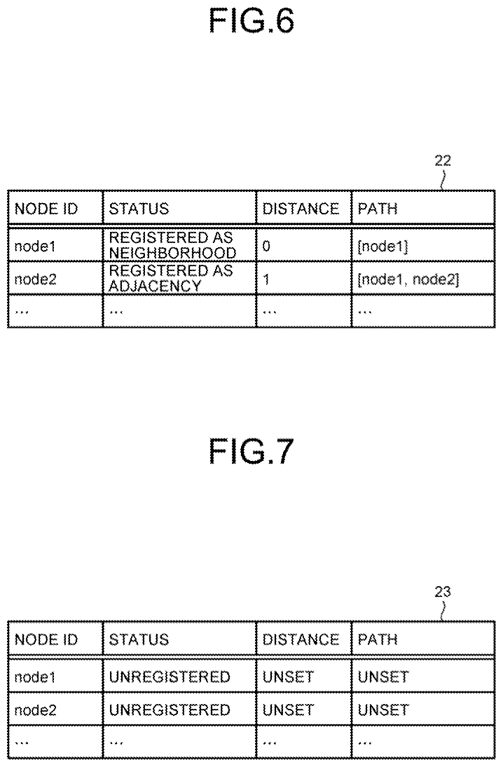

Here, the data structure of the edge list 212 will be described with reference to FIG. 5. In FIG. 5, the edge list 212 stores therein an edge ID, a starting point, an end point, weight, and a target edge in association with each other. The edge ID indicates an identifier for identifying an edge. The starting point indicates an identifier for identifying a starting point node of the edge. The end point indicates an identifier for identifying an end point node of the edge. The weight indicates far and near between the starting point node and the end point node indicated by the edge. Namely, weight indicates a distance. The target edge indicates an edge targeted for adding to the feature graph. In the item of the target edge, as an example, “O” is set when an edge is a target edge to be added to the feature graph, whereas “X” is set when an edge is not a target edge that is not to be added to the feature graph. Furthermore, “X” may also be set as a default of the target node.

As an example, when the edge ID is “edge1”, “node1” is stored as the starting point, “node2” is stored as the end point, “1” is stored as the weight, and “O” is stored as the target edge.

A description will be given here by referring back to FIG. 1, the starting point purpose table 22 is a table that stores therein information used when the shortest path search is conducted from the starting point. The end point purpose table 23 is a table that stores therein information used when the shortest path search is conducted from the end point. The variable table 24 is a table that stores therein variables used when the shortest path search is conducted from each of the starting point and the end point. Furthermore, the starting point purpose table 22, the end point purpose table 23, and the variable table 24 are used by the generating unit 12.

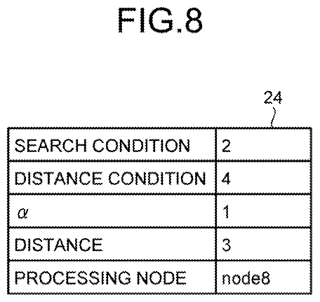

In the following, the data structure of the starting point purpose table 22 will be described with reference to FIG. 6. FIG. 6 is a diagram illustrating an example of the data structure of the starting point purpose table according to the embodiment. As illustrated in FIG. 6, the starting point purpose table 22 stores therein a node ID, a status, a distance, and a path in association with each other. The node ID is an identifier for identifying a node. The status indicates a state of a node that is being subjected to the shortest path search. The status includes, as an example, “unregistered”, “registered as neighborhood”, and “registered as adjacency”. The item of “unregistered” indicates that a node is in an initial state. Furthermore, “registered as neighborhood” indicates that the node has been registered as a neighboring node in the shortest path search. The item of “registered as adjacency” indicates that a node has been registered as an adjacent node adjacent to the neighboring node in the shortest path search. The distance indicates a distance from the starting point node. The path indicates a route from the starting point node.

As an example, when the node ID is “node1”, “registered as neighborhood” is stored as the status, and “O” is stored as the distance, “[node1]” is stored as the path. Namely, this indicates that “node1” is the starting point node. Furthermore, when the node ID is “node2”, “registered as adjacency” is stored as the status, “1” is stored as the distance, and “[node1,node2]” is stored as the path.

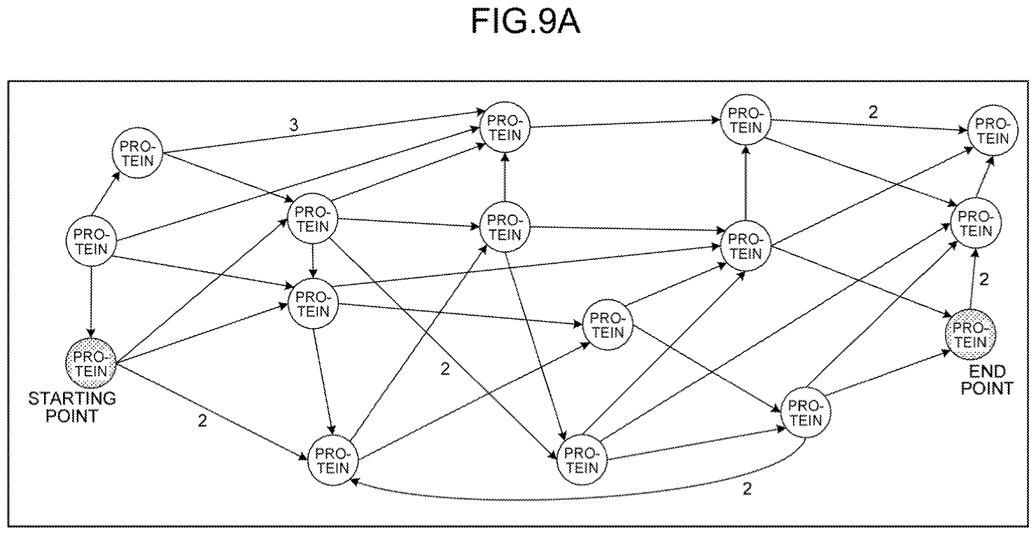

In the following, the data structure of the end point purpose table 23 will be described with reference to FIG. 7. FIG. 7 is a diagram illustrating an example of the data structure of the end point purpose table according to the embodiment. As illustrated in FIG. 7, the end point purpose table 23 stores therein a node ID, a status, a distance, and a path in association with each other. The node ID is an identifier for identifying a node. The status indicates a state of a node that is being subjected to the shortest path search. An example of the status is the same as that of the starting point purpose table 22; therefore, descriptions thereof will be omitted. The distance indicates a distance from the end point node. The path indicates a route from the end point node.

As an example, when the node ID is “node2”, “unregistered” is stored as the status, “unset” is stored as the distance, and “unset” is stored as the path.

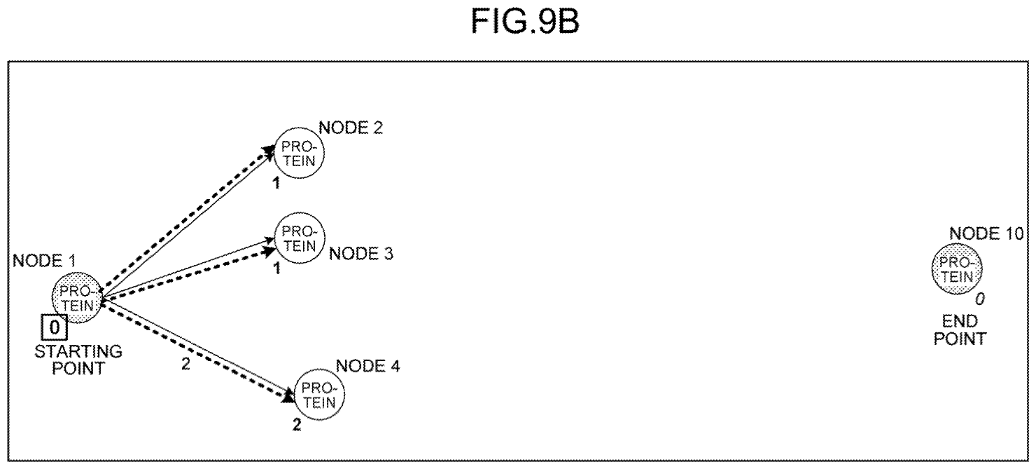

In the following, an example of the variable table 24 will be described with reference to FIG. 8. FIG. 8 is a diagram illustrating an example of the variable table according to the embodiment. As illustrated in FIG. 8, the variable table 24 stores therein a search condition, a distance condition, a, a distance, and a processing node in association with each other. The search condition indicates a condition that how far a shortest path search is conducted from each of the starting point and the end point. The distance condition is the distance condition from the starting point to the end point to be added to the feature graph. Namely, the distance condition is a condition related to the distance of a path from the starting point to the end point that can be added to the feature graph. The distance indicates the distance of the shortest path from the starting point to the end point. The symbol α is a value related to allowance that is used to conduct the shortest path search by making allowance for the distance of the shortest path. The processing node indicates a node that is being subjected to the shortest path search.

A description will be given here by referring back to FIG. 1, the feature graph 25 is a graph, in the directed graph indicating the knowledge base 21, generated by adding paths that connect the starting point node and the end point node whose relationship is desired to be estimated and peripheral information of the paths. Namely, the feature graph 25 is a graph representing the feature of the relationship between the starting point node and the end point node whose relationship is desired to be estimated. Furthermore, an example of the feature graph 25 will be described later.

The learning unit 11 constructs the machine learning model 26 by performing machine learning by using a set of combinations of the type of the relationship between the starting point node and the end point node and the feature graph as an input. The type mentioned here is, as an example, correct or incorrect. For example, the learning unit 11 generates a feature graph including a path that connects a correct starting point node to the correct end point node. The learning unit 11 generates a feature graph including a path that connects an incorrect starting point node and an incorrect end point node. Furthermore, the feature graph is generated by the generating unit 12 that will be described later. Then, the learning unit 11 constructs the machine learning model 26 by performing machine learning by using a set of combinations of the type of the relationship between the starting point node and the end point node and the generated feature graph as an input.

The generating unit 12 includes a shortest path searching unit 121 and a feature graph generating unit 122.

The shortest path searching unit 121 specifies the first path group that is the result of the shortest path search conducted from the starting point node in the forward direction within the first distance. An example of the first path group includes the starting point purpose table 22. For example, the shortest path searching unit 121 obtains, in the forward direction from the starting point node and in the order closer to the starting point node, the shortest path and the distance of a neighboring node located near the starting point node and a tentative shortest path and a tentative distance of an adjacent node located adjacent to the neighboring node, and then adds the obtained data to the starting point purpose table 22. As an example, the shortest path searching unit 121 sets, in the starting point purpose table 22, the node ID of the neighboring node in the node ID, “registered as neighborhood” in the status, the distance from the starting point node in the distance, and the path from the starting point node in the path. The shortest path searching unit 121 sets, in the starting point purpose table 22, the node ID of the adjacent node in the node ID, “registered as adjacency” in the status, the distance from the starting point node in the distance, and the path from the starting point node in the path.

Furthermore, the shortest path searching unit 121 specifies the second path group that is the result of the shortest path search conducted from the end point node in the reverse direction within the second distance. An example of the second path group includes the end point purpose table 23. For example, the shortest path searching unit 121 calculates, in the reverse direction from the end point node and in the order closer to the end point node, the shortest path and the distance of the neighboring node near the end point node and the tentative shortest path and the tentative distance of an adjacent node located adjacent to the neighboring node, and then adds the obtained data to the end point purpose table 23. As an example, the shortest path searching unit 121 sets, in the end point purpose table 23, the node ID of the neighboring node in the node ID, “registered as neighborhood” in the status, the distance from the end point node in the distance, and the path from the end point node in the path. The shortest path searching unit 121 sets, in the end point purpose table 23, the node ID of the adjacent node in the node ID, “registered as adjacency” in the status, the distance from the starting point node in the distance, and the path from the starting point node in the path.

Furthermore, if the neighboring node processed in the forward direction from the starting point node (or in the reverse direction from the end point node) is already registered as a neighboring node in the reverse direction (or in the forward direction) for the first time, the shortest path searching unit 121 performs the following process. The shortest path searching unit 121 set, in the distance in the variable table 24, the sum of the distance from the starting point node and the distance from the end point node as the distance of the shortest path from the starting point node to the end point node. Furthermore, the shortest path searching unit 121 sets the “distance of the shortest path+α” as the search condition for conducting the shortest path search in the search condition in the variable table 24. Furthermore, the symbol α is a value related to allowance that is used to conduct the shortest path search by making allowance for the distance of the shortest path. Furthermore, the shortest path searching unit 121 sets the “distance of the shortest path+α” as a distance condition in the distance condition in the variable table 24. Furthermore, when the shortest path searching unit 121 conducts the shortest path search by using Dijkstra's algorithm, the shortest path searching unit 121 sets the “(distance of the shortest path+α)/2” as the search condition for conducting the shortest path search in the search condition in the variable table 24.

Furthermore, when the search condition is set, the shortest path searching unit 121 performs the following process. The shortest path searching unit 121 performs the shortest path search until the distance of the next neighboring node from the starting point node or the end point node exceeds the search condition. When the distance of the next neighboring node from the starting point node or the end point node exceeds the search condition, the shortest path searching unit 121 ends the shortest path search.

Regarding each of the nodes included in both of the first path group and the second path group, the feature graph generating unit 122 determines whether the sum of the distance of the first shortest path from the starting point node to the subject node and the distance of the second shortest path from the subject node to the end point node is less than or equal to the distance condition. Then, when the sum of the distance of the first shortest path from the starting point node to the subject node and the distance of the second shortest path from the subject node to the end point node is less than or equal to the distance condition, the feature graph generating unit 122 adds the path obtained by adding up the first shortest path and the second shortest path to the feature graph 25.

When the estimating unit 13 inputs the starting point node and the end point node, the estimating unit 13 estimates the relationship between the input starting point node and end point node by using the machine learning model 26. For example, when the estimating unit 13 inputs the starting point node and the end point node, the estimating unit 13 generates a feature graph including the path that connects the input starting point node and the end point node. Furthermore, the feature graph is generated by the generating unit 12 that will be described later. Then, the estimating unit 13 inputs the generated feature graph to the machine learning model 26 and estimates the relationship between the starting point node and the end point node. Namely, the estimating unit 13 estimates whether the relationship between the input starting point node and the input end point node is correct or incorrect.

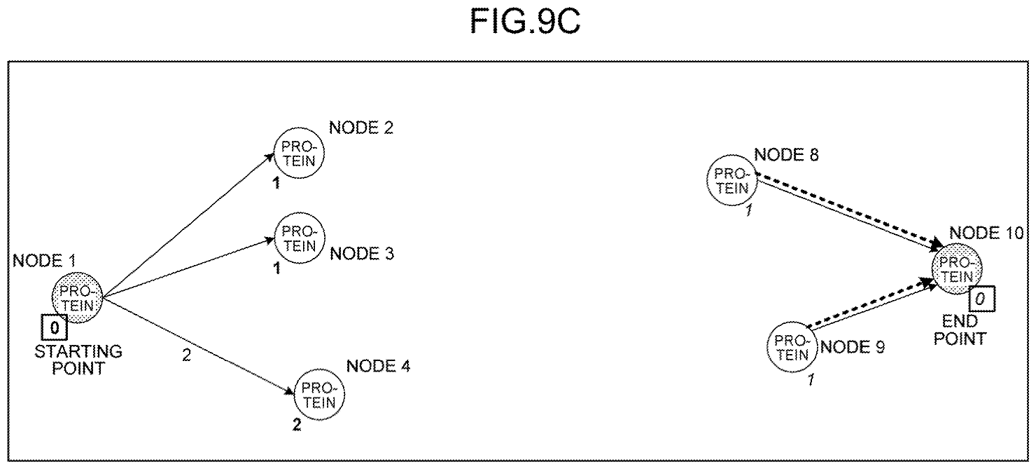

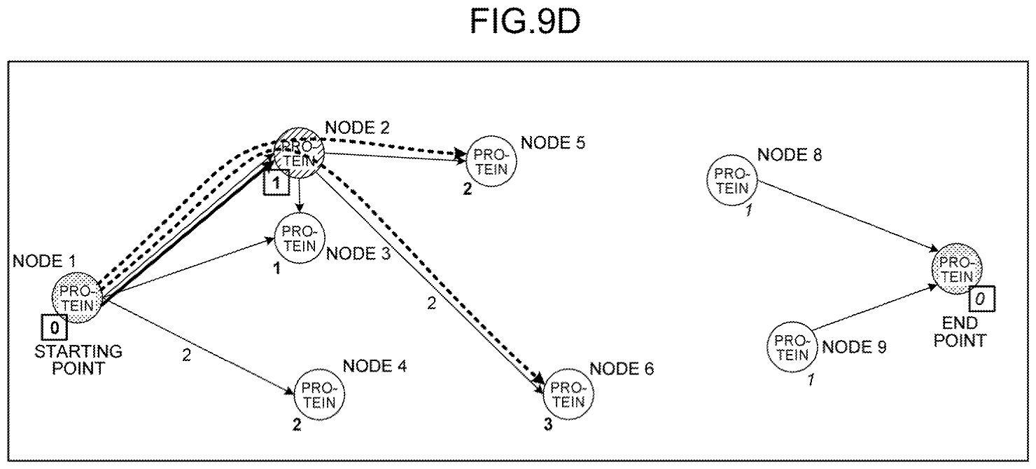

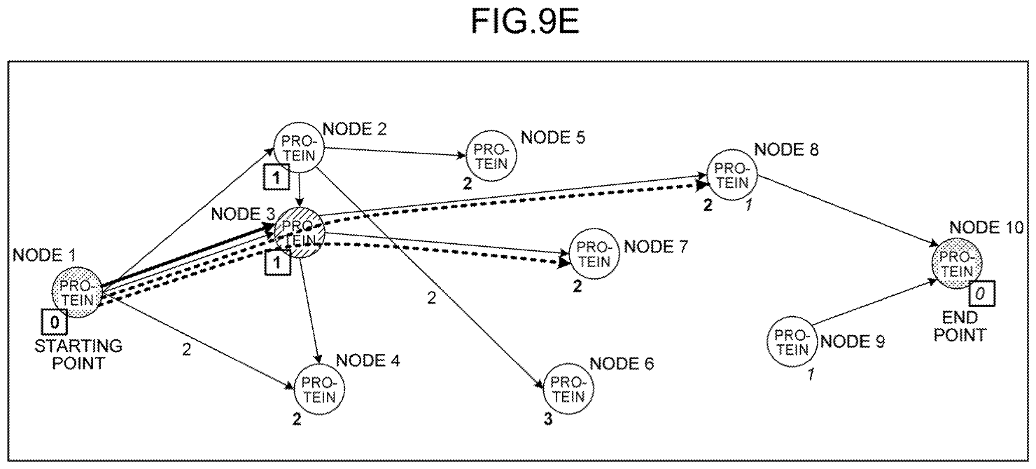

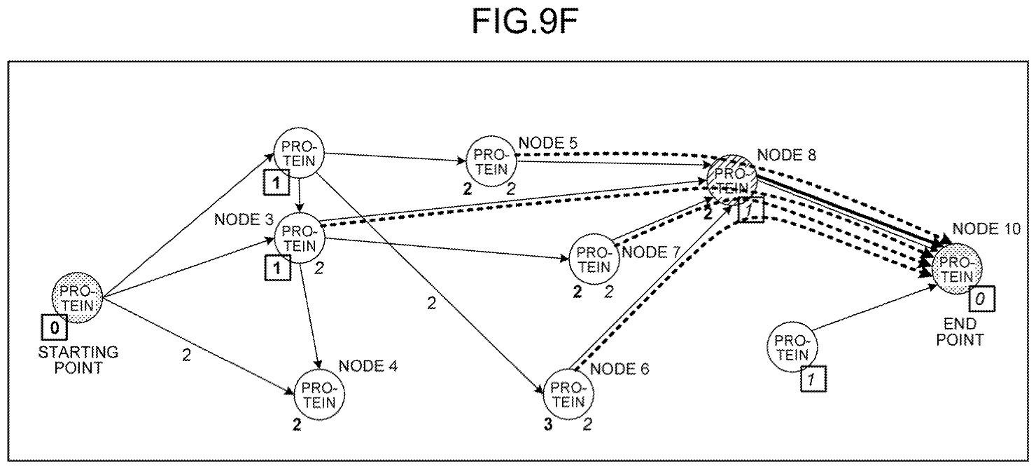

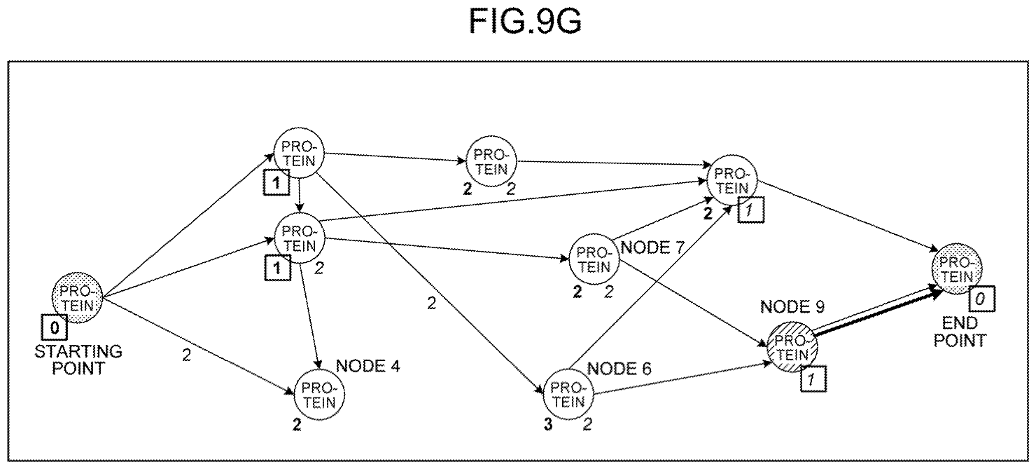

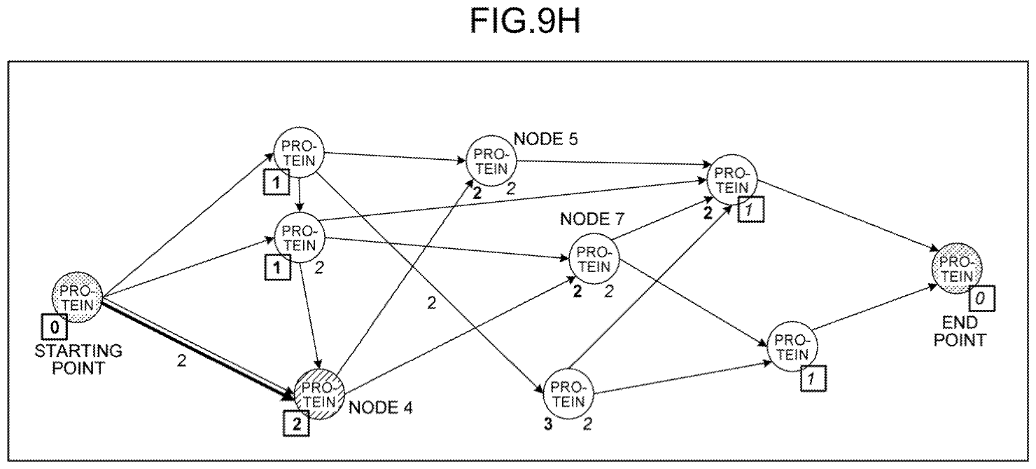

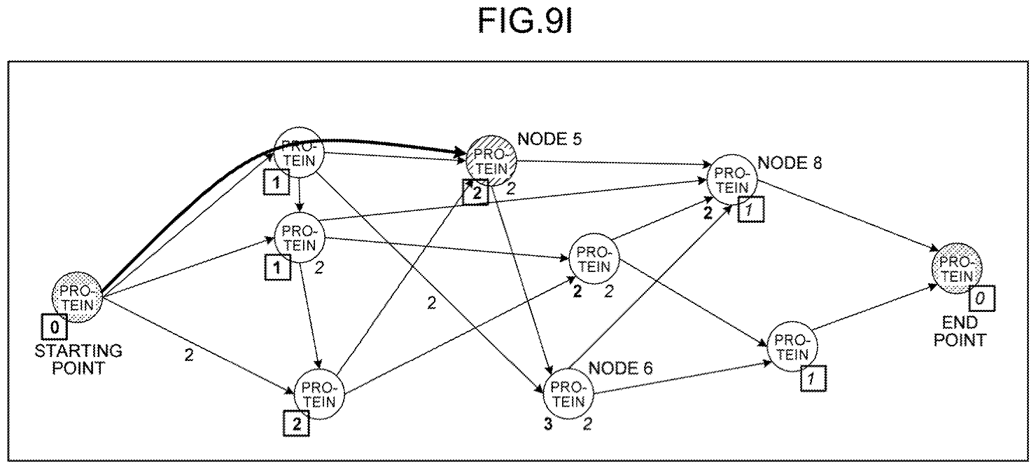

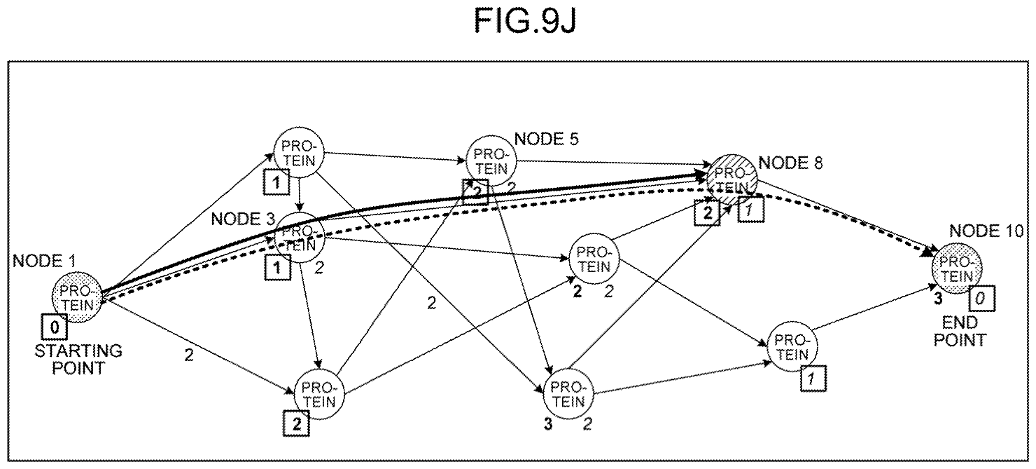

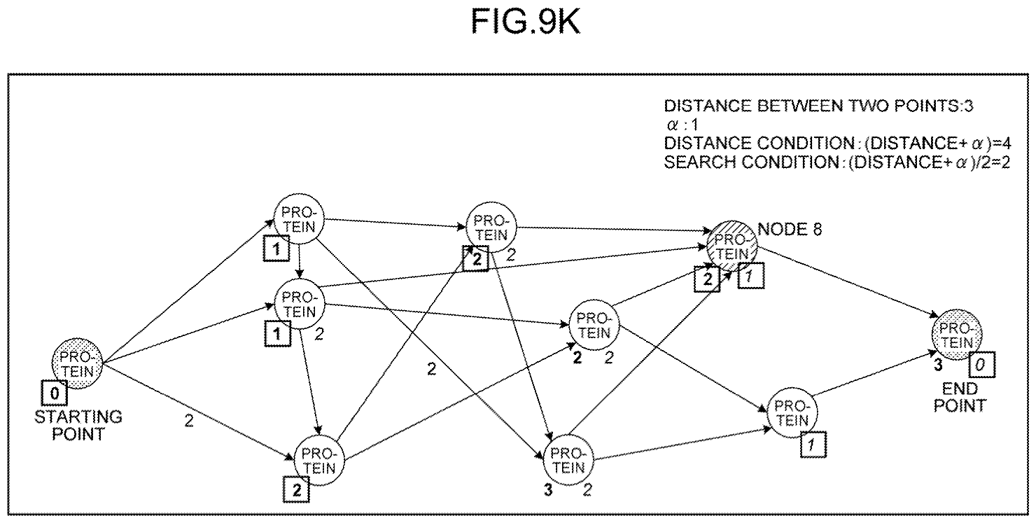

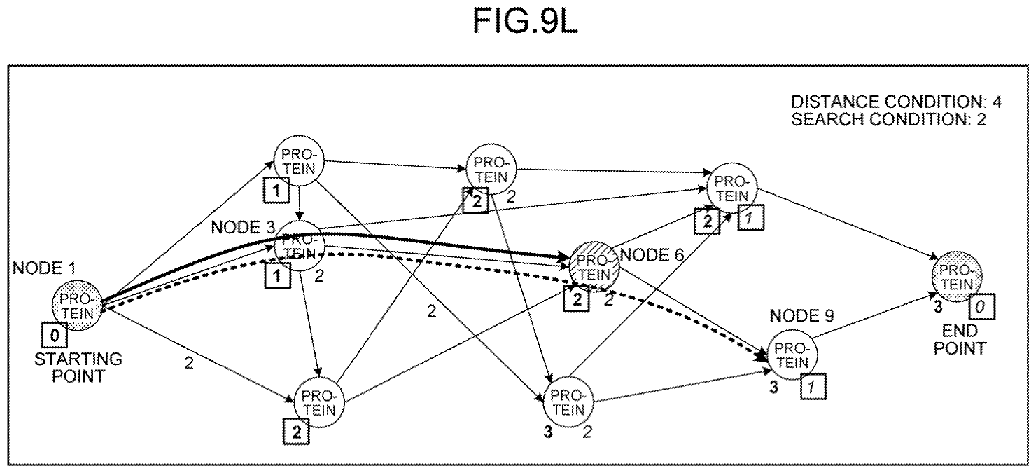

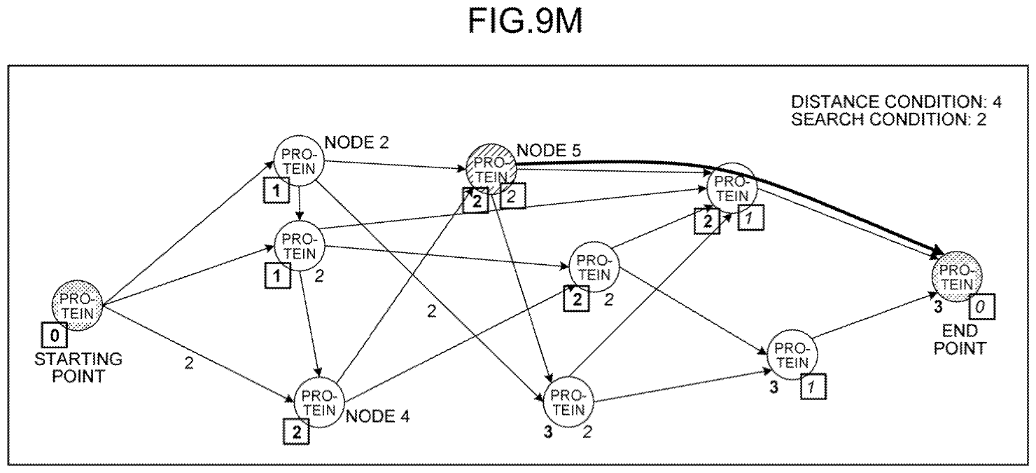

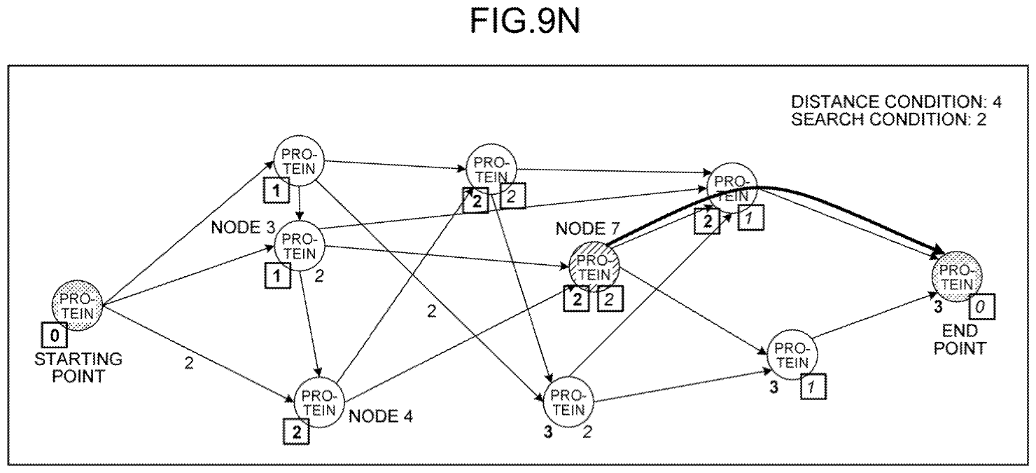

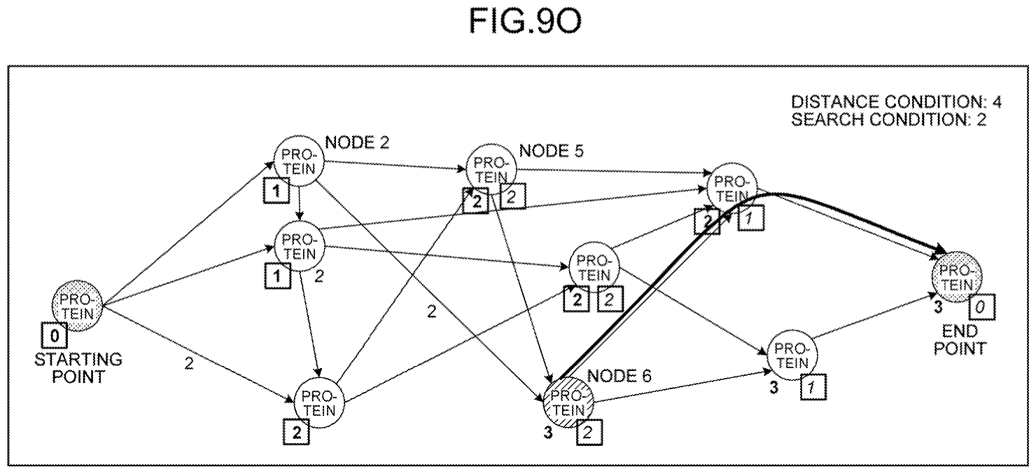

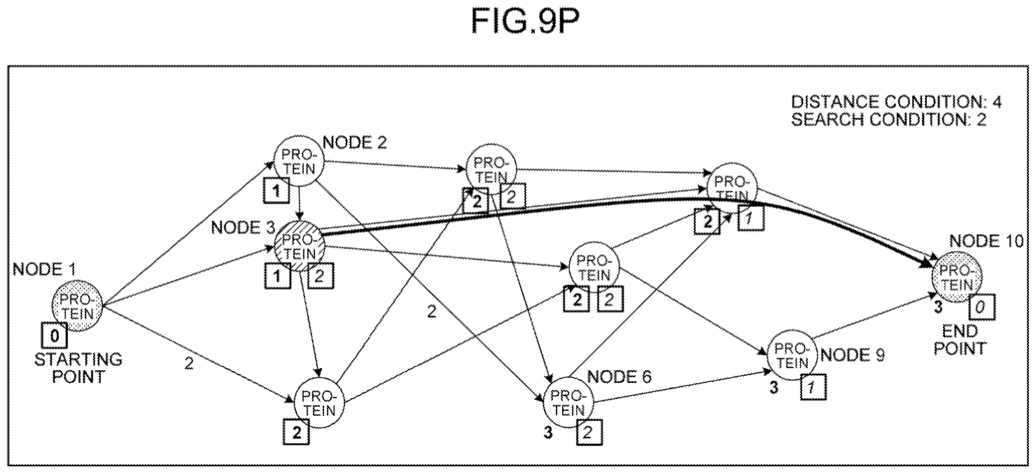

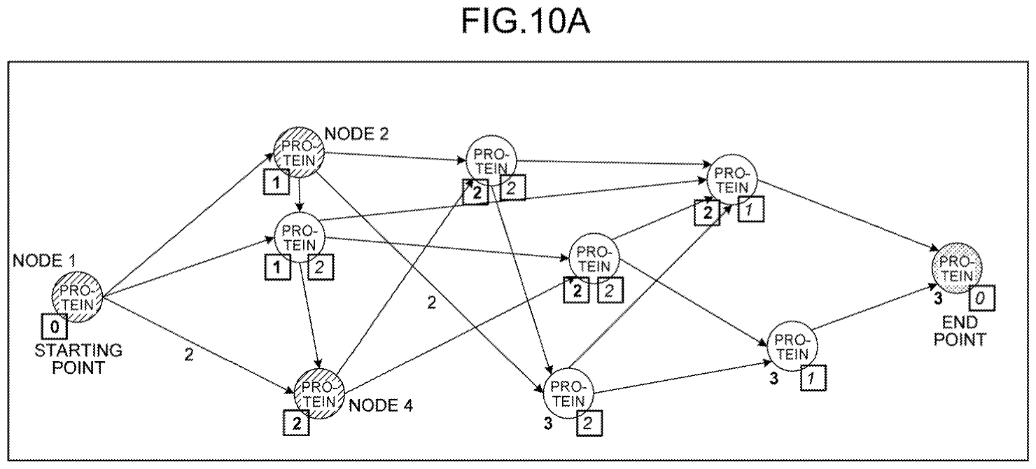

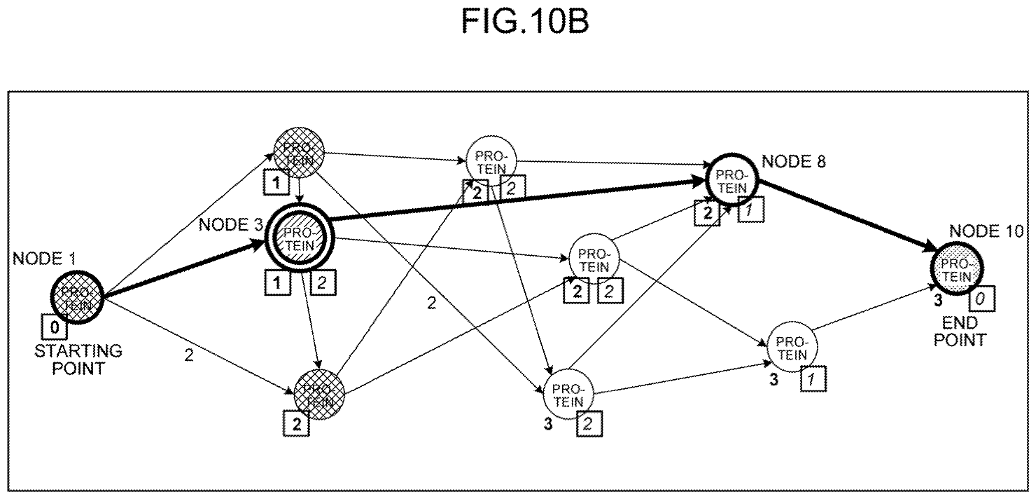

In the following, an example of the flow of the shortest path searching process according to the embodiment will be described with reference to FIG. 9A to FIG. 9P. FIG. 9A to FIG. 9P are diagrams each illustrating an example of the flow of a shortest path searching process according to the embodiment. Furthermore, here, a description will be given of a case of using Dijkstra's algorithm as the shortest path search method.

First, the shortest path searching unit 121 receives the starting point node and the end point node from the learning unit 11. Furthermore, the shortest path searching unit 121 may also receive the starting point node and the end point node from the estimating unit 13. As illustrated in FIG. 9A, regarding the directed graph indicating the knowledge base 21, the starting point node and the end point node are indicated in gray. Here, the starting point node is a node 1 and the end point node is a node 10. Furthermore, each of the numbers beside the edges in the directed graph represents a distance (weight) between the nodes.

Then, the shortest path searching unit 121 obtains, in the forward direction from the starting point node, the shortest path and the distance of the neighboring node having the smallest distance from the starting point node and adds the obtained data to the starting point purpose table 22. Furthermore, the shortest path searching unit 121 obtains the tentative shortest path and the tentative distance of the adjacent node adjacent to the neighboring node and adds the obtained data to the starting point purpose table 22. Here, as illustrated in FIG. 9B, the neighboring node having the smallest distance from the starting point node is the own “node 1” having the distance of “0”. Thus, the shortest path searching unit 121 sets, by using the “node 1” as the neighboring node, the distance of the “node 1” to “0” and the shortest path to “[node1]”. The number “0” in a square attached to the lower left of the “node 1” is the distance of the neighboring node from the starting point node. Furthermore, the adjacent nodes adjacent to the “node 1” are a “node 2”, a “node 3”, and a “node 4”. Thus, the shortest path searching unit 121 sets, by identifying the “node 2” as the adjacent node, the tentative distance of the “node 2” to “1” and the shortest path to “[node1, node2]”. The number “1” without a square attached to the lower left of the “node 2” is the tentative distance of the adjacent node from the starting point node. Similarly, the shortest path searching unit 121 sets, by identifying the “node 3” as the adjacent node, the tentative distance of the “node 3” to “1” and the shortest path to “[node1, node3]. The shortest path searching unit 121 sets, by identifying the “node 4” as the adjacent node, the tentative distance of the “node 4” to “2” and the shortest path to “[node1, node4]”.

Then, the shortest path searching unit 121 obtains, in the reverse direction from the end point node, the shortest path and the distance of the neighboring node having the smallest distance from the end point node and adds the obtained data to the end point purpose table 23. In addition, the shortest path searching unit 121 obtains tentative shortest path and the tentative distance of the adjacent node that is adjacent to the neighboring node and adds the obtained data to the end point purpose table 23. Here, as illustrated in FIG. 9C, the neighboring node having the smallest distance from the end point node is the own “node 10” having the distance of “0”. Thus, the shortest path searching unit 121 sets, by identifying the “node 10” as the neighboring node, the distance of the “node 10” to “0” and the shortest path to “[node10]”. The number “0” in a square attached to the lower right of the “node 10” is the distance of the neighboring node from the end point node. Furthermore, the adjacent nodes adjacent to the “node 10” are a “node 8” and a “node 9”. Thus, the shortest path searching unit 121 sets, by identifying the “node 8” as the adjacent node, tentative distance of the “node 8” to “1” and the shortest path to “[node8, node10]”. The number “1” without a square attached to the lower right of the “node 8” is the tentative distance of the adjacent node from the end point node. Similarly, the shortest path searching unit 121 sets, by identifying the “node 9” as the adjacent node, the tentative distance of the “node 9” to “1”. The shortest path searching unit 121 sets, by identifying the “node 9” as the adjacent node, the tentative distance of the “node 9” to “1” and the shortest path to “[node9, node10]”.

Then, the shortest path searching unit 121 obtains, by identifying the node having the smallest distance from the next starting point node as the neighboring node, the shortest path and the distance of the neighboring node and records the obtained data in the starting point purpose table 22. In addition, the shortest path searching unit 121 obtains the tentative shortest path and the tentative distance of the adjacent node adjacent to the neighboring node and adds the obtained data to the starting point purpose table 22. Here, as illustrated in FIG. 9D, the neighboring node having the smallest distance from the starting point node is the “node 2” having the distance of “1”. Thus, the shortest path searching unit 121 updates the “node 2” to the neighboring node. The number “1” in a square attached to the lower left of the “node 2” is the distance of the neighboring node from the starting point node. Furthermore, the adjacent nodes adjacent to the “node 2” are a “node 5” and a “node 6”. Thus, the shortest path searching unit 121 sets, by identifying the “node 5” as the adjacent node, the tentative distance of the “node 5” to “2” and the shortest path to “[node1, node2], [node2, node5]”. The number “2” without a square attached to the lower left of the “node 5” is the tentative distance of the adjacent node from the starting point node. Similarly, the shortest path searching unit 121 sets, by identifying the “node 6” as the adjacent node, the tentative distance of the “node 6” to “3”.

Then, the shortest path searching unit 121 obtains, by identifying the node having the smallest distance from the next starting point node as the neighboring node, the shortest path and the distance of the neighboring node and records the obtained data in the starting point purpose table 22. In addition, the shortest path searching unit 121 obtains the tentative shortest path and the tentative distance of the adjacent node adjacent to the neighboring node and adds the obtained data to the starting point purpose table 22. Here, as illustrated in FIG. 9E, the neighboring node having the smallest distance from the starting point node is the “node 3” having the distance of “1”. Thus, the shortest path searching unit 121 updates the “node 3” to the neighboring node. The number “1” in a square attached to the lower left of the “node 3” is the distance of the neighboring node from the starting point node. Furthermore, the adjacent nodes adjacent to the “node 3” are the “node 8” and a “node 7”. Thus, the shortest path searching unit 121 sets, by identifying the “node 8” as the adjacent node, the tentative distance of the “node 8” to “2” and the shortest path to “[node1, node3], [node3, node8]”. The number “2” without a square attached to the lower left of the “node 8” is “2” that indicates the tentative distance of the adjacent node from the starting point node. Similarly, the shortest path searching unit 121 sets, by identifying the “node 7” as the adjacent node, the tentative distance of the “node 7” to “2”.

Then, because the node having the smallest distance from the next starting point node is the “node 4” indicating the distance “2” and is greater than the “node 8” having the smallest distance from the next end point node, the shortest path searching unit 121 sets the “node 8” having the smallest distance from the next end point node to the neighboring node. Then, the shortest path searching unit 121 obtains the shortest path and the distance of the neighboring node and records the obtained data in the end point purpose table 23. In addition, the shortest path searching unit 121 obtains the tentative shortest path and the tentative distance of the adjacent node adjacent to the neighboring node and records the obtained data in the end point purpose table 23. Here, as illustrated in FIG. 9F, the neighboring node having the smallest distance from the end point node is the “node 8” having the distance of “1”. Thus, the shortest path searching unit 121 updates the “node 8” to the neighboring node. The number “1” in a square attached to the lower right of the “node 8” is the distance of the neighboring node from the end point node. Furthermore, the adjacent nodes adjacent to the “node 8” are the “node 5”, the “node 7”, and the “node 6”. Thus, the shortest path searching unit 121 sets, by identifying the “node 5” as the adjacent node, the tentative distance of the “node 5” to “2” and the shortest path to “[node5, node8], [node8, node10]”. The number “2” without a square attached to the lower right of the “node 5” is the tentative distance of the adjacent node from the end point node. Similarly, the shortest path searching unit 121 sets, by identifying the “node 7” as the adjacent node, the tentative distance of the “node 7” to “2”. The shortest path searching unit 121 sets, by identifying the “node 6” as the adjacent node, the tentative distance of the “node 6” to “2”.

Then, because the node having the smallest distance from the next starting point node is the “node 4” indicating the distance “2” and is greater than the “node 9” having the smallest distance from the next end point node, the shortest path searching unit 121 sets the “node 9” having the smallest distance from the next end point node to the neighboring node. Then, the shortest path searching unit 121 obtains the shortest path and the distance of the neighboring node and records the obtained data in the end point purpose table 23. In addition, the shortest path searching unit 121 obtains the tentative shortest path and the tentative distance of the adjacent node adjacent to the neighboring node and adds the obtained data to the end point purpose table 23. Here, as illustrated in FIG. 9G, the neighboring node having the smallest distance from the end point node is the “node 9” having the distance of “1”. Thus, the shortest path searching unit 121 updates the “node 9” to the neighboring node. The number “1” in a square attached to the lower right of the “node 9” is the distance of the neighboring node from the end point node. Furthermore, the adjacent nodes adjacent to the “node 9” are the “node 7” and the “node 6”. However, the “node 7” and the “node 6” as the adjacent node of the “node 9” have the same tentative distance that has respectively been set. Thus, the shortest path searching unit 121 does not update the tentative shortest path and the tentative distance of the adjacent node adjacent to the “node 9” serving as the neighboring node.

Then, because the node having the smallest distance from the next starting point node is the “node 4” indicating the distance “2” and is the same as the node having the smallest distance from the next end point node, the shortest path searching unit 121 sets the “node 4” to the neighboring node. Then, the shortest path searching unit 121 obtains the shortest path and the distance of the neighboring node and records the obtained data in the starting point purpose table 22. In addition, the shortest path searching unit 121 obtains the tentative shortest path and the tentative distance of the adjacent node adjacent to the neighboring node and adds the obtained data to the starting point purpose table 22. Here, as illustrated in FIG. 9H, the neighboring node having the smallest distance from the starting point node is the “node 4” having the distance of “2”. Thus, the shortest path searching unit 121 updates the “node 4” to the neighboring node. The number “2” in a square attached to the lower left of the “node 4” is the distance of the neighboring node from the starting point node. Furthermore, the adjacent nodes adjacent to the “node 4” are the “node 5” and the “node 7”. However, the “node 5” and the “node 7” serving as the adjacent node of the “node 4” have the tentative distance greater than that that has respectively been set. Thus, the shortest path searching unit 121 does not update the tentative shortest path and the tentative distance of the adjacent node adjacent to the “node 4” serving as the neighboring node.

Then, the shortest path searching unit 121 obtains, by identifying the node having the smallest distance from the next starting point node as the neighboring node, the shortest path and the distance of the neighboring node and records the obtained data in the starting point purpose table 22. In addition, the shortest path searching unit 121 obtains the tentative shortest path and the tentative distance of the adjacent node adjacent to the neighboring node and adds the obtained data in the starting point purpose table 22. Here, as illustrated in FIG. 9I, the neighboring node having the smallest distance from the starting point node is the “node 5” having the distance of “2”. Thus, the shortest path searching unit 121 updates the “node 5” to the neighboring node. The number “2” in a square attached to the lower left of the “node 5” is the distance of the neighboring node from the starting point node. Furthermore, the adjacent nodes adjacent to the “node 5” are the “node 8” and the “node 6”. However, the “node 8” and the “node 6” serving as the adjacent node of the “node 5” have the tentative distance equal to or greater than the tentative distance that has respectively been set. Thus, the shortest path searching unit 121 does not update the tentative shortest path and the tentative distance of the adjacent node adjacent to the “node 4” serving as the neighboring node.

Then, the shortest path searching unit 121 obtains, by identifying the node having the smallest distance from the next starting point node as the neighboring node, the shortest path and the distance of the neighboring node and adds the obtained data in the starting point purpose table 22. In addition, the shortest path searching unit 121 obtains the tentative shortest path and the tentative distance of the adjacent node adjacent to the neighboring node and adds the obtained data to the starting point purpose table 22. Here, as illustrated in FIG. 9J, the neighboring node having the smallest distance from the starting point node is the “node 8” having the distance of “2”. Thus, the shortest path searching unit 121 updates the “node 8” to the neighboring node. The number “2” in a square attached to the lower left of the “node 8” is the distance of the neighboring node from the starting point node. Furthermore, the adjacent node adjacent to the “node 8” is the “node 10”. Thus, the shortest path searching unit 121 sets, by identifying the “node 10” as the adjacent node, tentative distance of the “node 10” to “3” and the shortest path to “[node1, node3], [node3, node5], [node5, node8], [node8, node10]”. The number “3” without a square attached to the lower left of the “node 10” is the tentative distance of the adjacent node from the starting point node.

The “node 8” is stored in the starting point purpose table 22 as the neighboring node from the starting point node and is stored in the end point purpose table 23 as the neighboring node from the end point node. Thus, the shortest path searching unit 121 sets, in the distance in the variable table 24, the sum of the distance from the starting point node and the distance from the end point node as the distance of the shortest path from the starting point node to the end point node. Here, the sum “3” of the distance “2” from the starting point node and the distance “1” from the end point node is set in the distance in the variable table 24 as the distance of the shortest path between two points. Furthermore, the shortest path searching unit 121 sets the “distance of the shortest path+α” as the distance condition in the variable table 24. Here, if α is previously set to “1” in the variable table 24, “4” obtained by adding the distance “3” of the shortest path to “1” indicating a is set in the distance condition in the variable table 24. Furthermore, the shortest path searching unit 121 sets the “(distance of the shortest path+α)/2” in the variable table 24 as the search condition for conducting the shortest path search. Here, “2” is set in the search condition.

Then, the shortest path searching unit 121 obtains, by identifying the node having the smallest distance from the next starting point node as the neighboring node, the shortest path and the distance of the neighboring node and records the obtained data in the starting point purpose table 22. In addition, the shortest path searching unit 121 obtains the tentative shortest path and the tentative distance of the adjacent node adjacent to the neighboring node and adds the obtained data to the starting point purpose table 22. Here, as illustrated in FIG. 9L, the neighboring node having the smallest distance from the starting point node is the “node 6” having the distance of “2”. Thus, the shortest path searching unit 121 updates the “node 6” to the neighboring node. The number “2” in a square attached to the lower left of the “node 6” is the distance of the neighboring node from the starting point node. Furthermore, the adjacent node adjacent to the “node 6” is the “node 9”. Thus, the shortest path searching unit 121 sets, by identifying the “node 9” as the adjacent node, the tentative distance of the “node 9” to “3” and the shortest path to “[node1, node3], [node3, node6], [node6, node9]”. The number “3” without a square attached to the lower left of the “node 9” is the tentative distance of the adjacent node from the starting point node.

Then, because the distance of the next neighboring node is smaller from the end point node, the shortest path searching unit 121 sets the “node 5” having the second smallest distance from the end point node to the neighboring node. Then, the shortest path searching unit 121 obtains the shortest path and the distance of the neighboring node and records the obtained data in the end point purpose table 23. In addition, the shortest path searching unit 121 obtains the tentative shortest path and the tentative distance of the adjacent node adjacent to the neighboring node and adds the obtained data to the end point purpose table 23. Here, as illustrated in FIG. 9M, the neighboring node having the second smallest distance from the end point node is the “node 5” having the distance of “2”. Thus, the shortest path searching unit 121 updates the “node 5” to the neighboring node. The number “2” in a square attached to the lower right of the “node 5” is the distance of the neighboring node from the end point node. Furthermore, the adjacent nodes adjacent to the “node 5” are the “node 2” and the “node 4”. However, each of the “node 2” and the “node 4” serving as the adjacent node of the “node 5” exceeds “2” as the search condition. Thus, the shortest path searching unit 121 does not record the tentative shortest path and the tentative distance of the adjacent node adjacent to the “node 4” serving as the neighboring node.

Then, because the distance of the next neighboring node is smaller from the end point node, the shortest path searching unit 121 sets the “node 7” having the second smallest distance from the end point node to the neighboring node. Then, the shortest path searching unit 121 obtains the shortest path and the distance of the neighboring node and records the obtained data in the end point purpose table 23. In addition, the shortest path searching unit 121 obtains the tentative shortest path and the tentative distance of the adjacent node adjacent to the neighboring node and adds the obtained data to the end point purpose table 23. Here, as illustrated in FIG. 9N, the neighboring node having the second smallest distance from the end point node is the “node 7” having the distance of “2”. Thus, the shortest path searching unit 121 updates the “node 7” to the neighboring node. The number “2” in a square attached to the lower right of the “node 7” is the distance of the neighboring node from the end point node. Furthermore, the adjacent nodes adjacent to the “node 7” are the “node 3” and the “node 4”. However, each of the “node 3” and the “node 4” serving as the adjacent nodes of the “node 7” exceeds “2” as the search condition. Thus, the shortest path searching unit 121 does not record the tentative shortest path and the tentative distance of the adjacent node adjacent to the “node 7” serving as the neighboring node.

Then, because the distance of the next neighboring node is smaller from the end point node, the shortest path searching unit 121 sets the “node 6” having the second smallest distance from the end point node to the neighboring node. Then, the shortest path searching unit 121 obtains the shortest path and the distance of the neighboring node and records in the end point purpose table 23. In addition, the shortest path searching unit 121 obtains the tentative shortest path and the tentative distance of the adjacent node adjacent to the neighboring node and adds the obtained data to the end point purpose table 23. Here, as illustrated in FIG. 9O, the neighboring node having the second smallest distance from the end point node is the “node 6” having the distance of “2”. Thus, the shortest path searching unit 121 updates the “node 6” to the neighboring node. The number “2” in a square attached to the lower right of the “node 6” is the distance of the neighboring node from the end point node. Furthermore, the adjacent nodes adjacent to the “node 6” are the “node 2” and the “node 5”. However, each of the “node 2” and the “node 5” serving as the adjacent node of the “node 6” exceeds “2” as the search condition. Thus, the shortest path searching unit 121 does not record the tentative shortest path and the tentative distance of the adjacent node adjacent to the “node 6” serving as the neighboring node.

Then, because the distance of the next neighboring node is smaller from the end point node, the shortest path searching unit 121 sets the “node 3” having the second smallest distance from the end point node to the neighboring node. Then, the shortest path searching unit 121 obtains the shortest path and the distance of the neighboring node and records the obtained data in the end point purpose table 23. In addition, the shortest path searching unit 121 obtains the tentative shortest path and the tentative distance of the adjacent node adjacent to the neighboring node and adds the obtained data to the end point purpose table 23. Here, as illustrated in FIG. 9P, the neighboring node having the second smallest distance from the end point node is the “node 3” having the distance of “2”. Thus, the shortest path searching unit 121 updates the “node 3” to the neighboring node. The number “2” in a square attached to the lower right of the “node 3” is the distance of the neighboring node from the end point node. Furthermore, the adjacent nodes adjacent to the “node 3” are the “node 1” and the “node 2”. However, each of the “node 1” and the “node 2” serving as the adjacent node of the “node 3” exceeds “2” as the search condition. Thus, the shortest path searching unit 121 does not record the tentative shortest path and the tentative distance of the adjacent node adjacent to the “node 3” serving as the neighboring node.

Then, If the distance of the next neighboring node from the starting point node or the end point node exceeds the search condition, the shortest path searching unit 121 ends the shortest path searching process. Here, the next neighboring nodes are the node 6, the node 9, and the node 10 each having the distance “3” from the starting point node. However, the distance “3” exceeds the search condition “2”. Thus, the shortest path searching unit 121 ends the shortest path searching process because the distance of the next neighboring node exceeds the search condition.

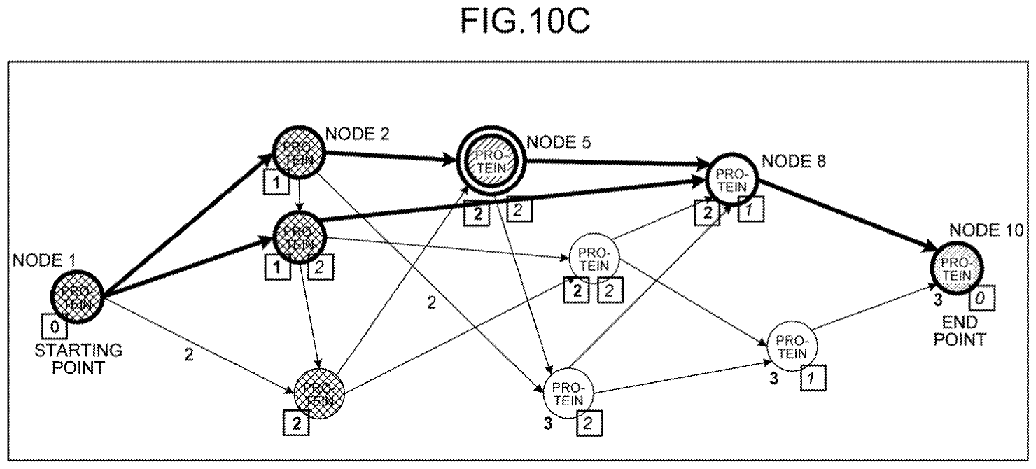

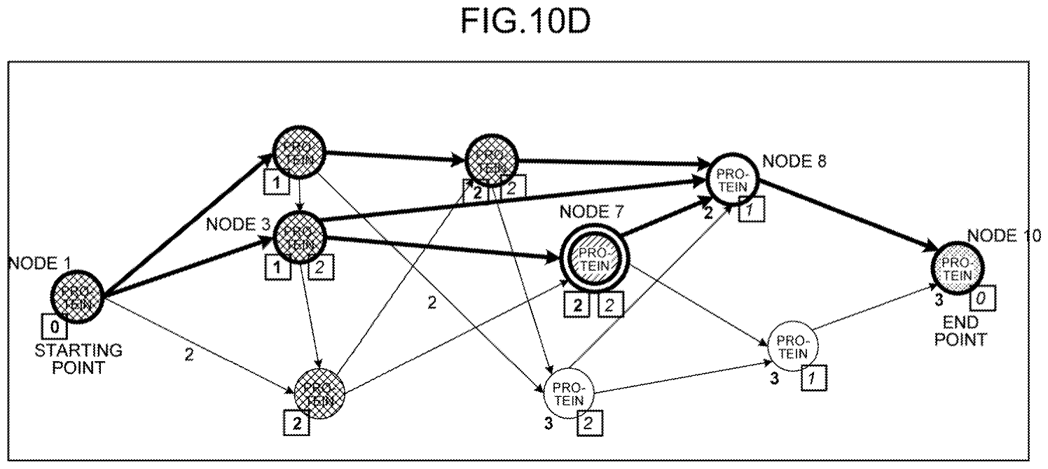

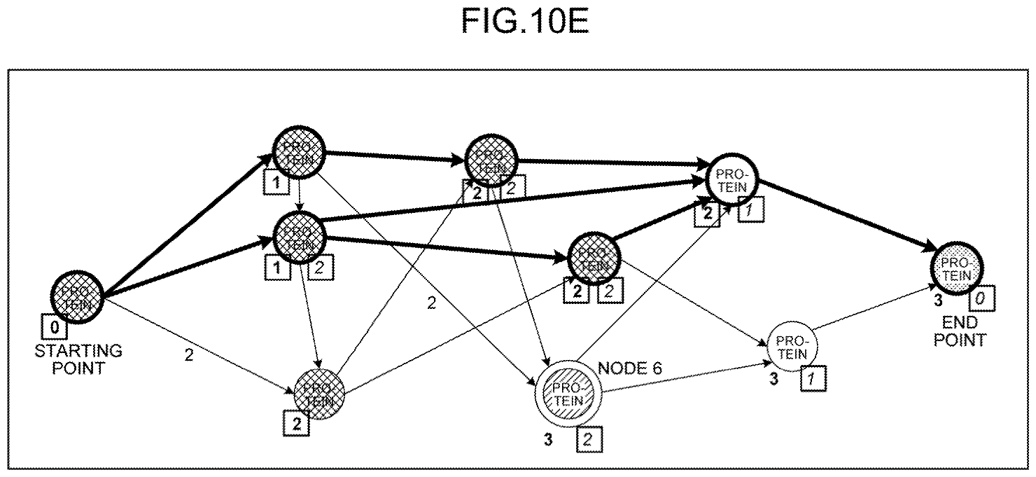

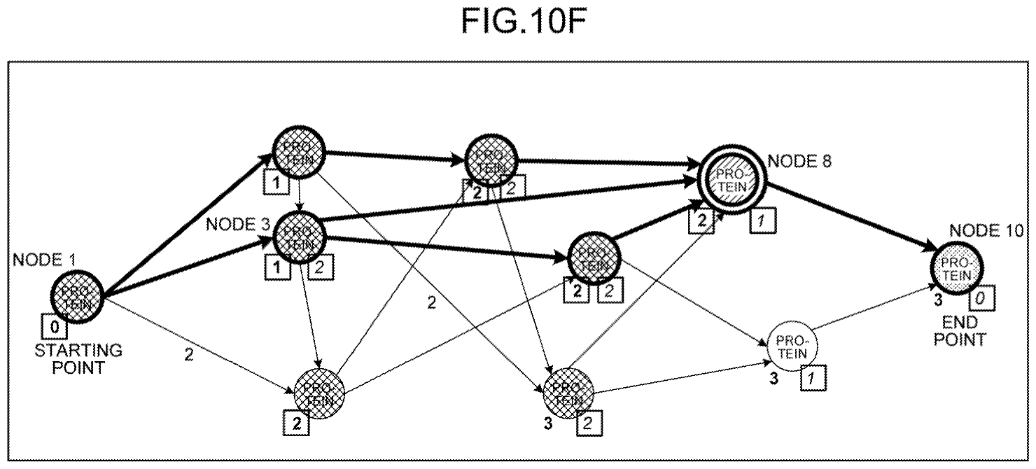

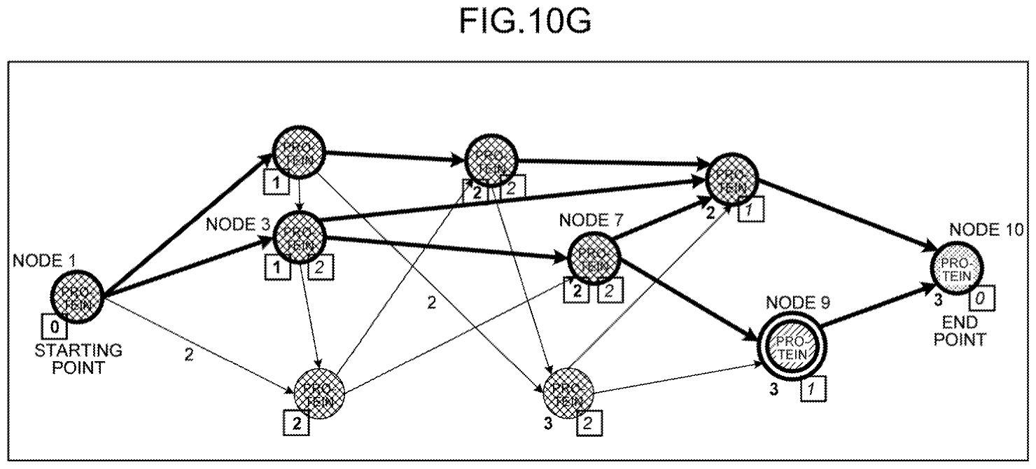

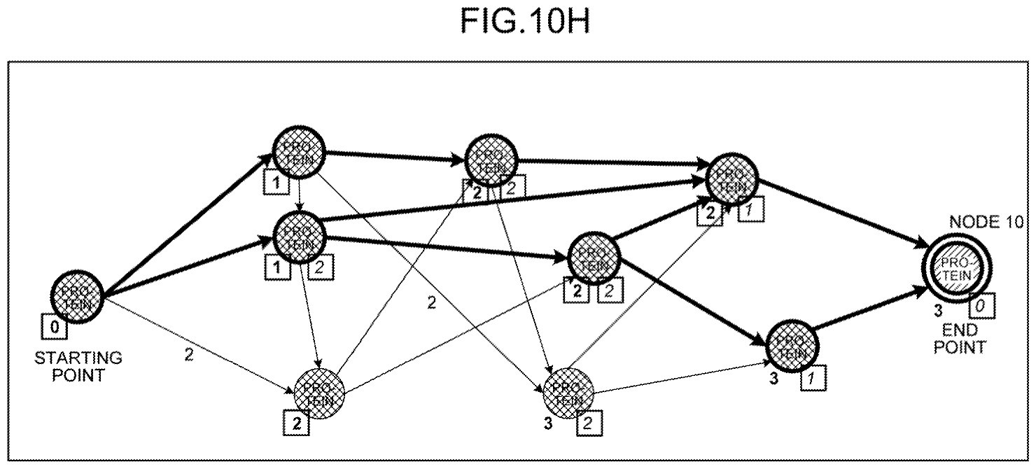

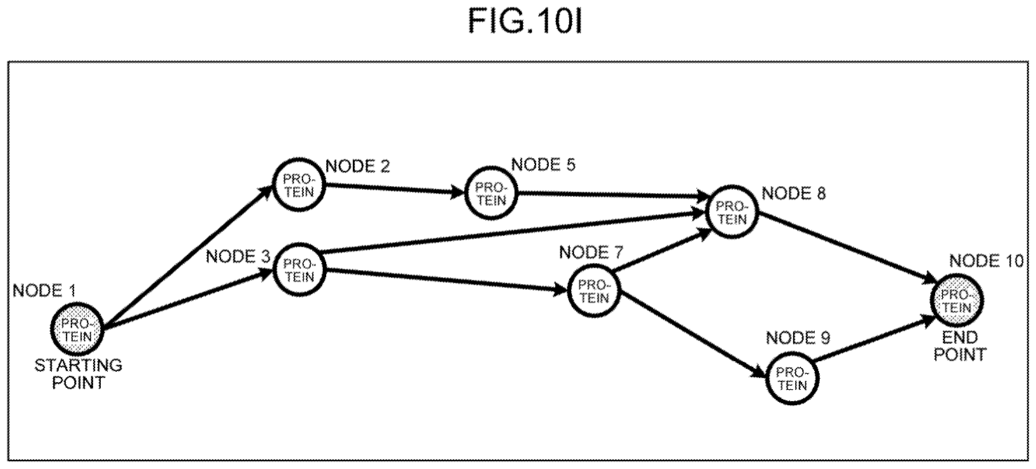

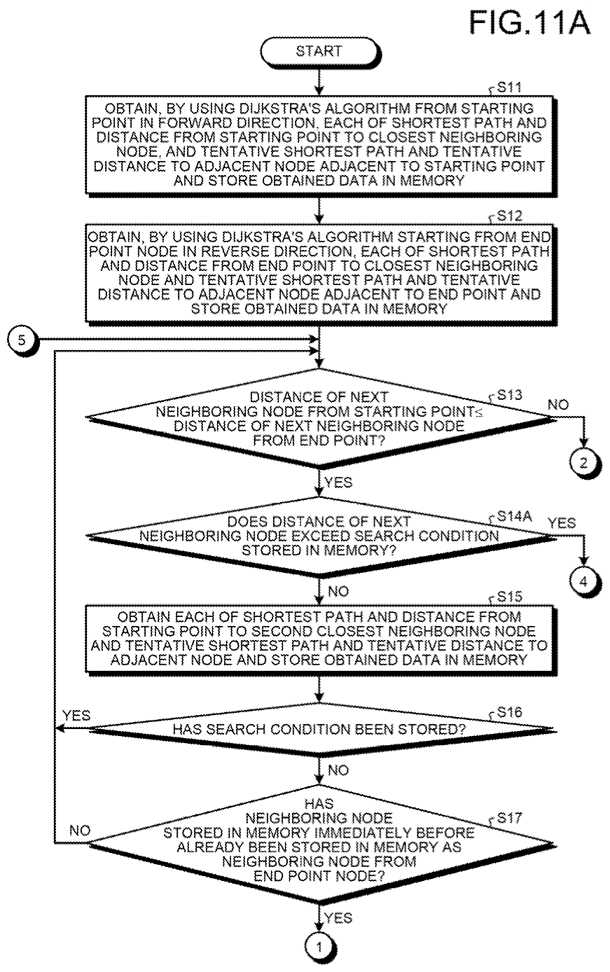

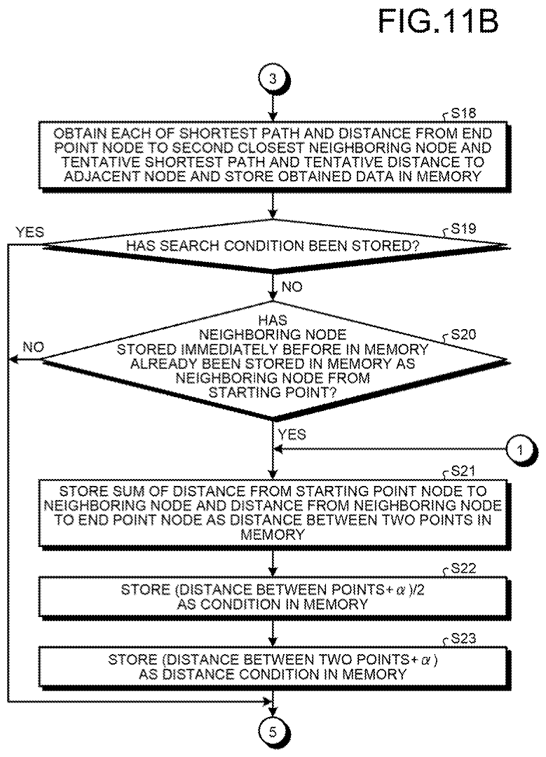

In the following, an example of the flow of the feature graph generating process according to the embodiment will be described with reference to FIG. 10A to FIG. 10I. FIG. 10A to FIG. 10I are diagrams each illustrating an example of the flow of a feature graph generating process according to the embodiment. Furthermore, in this example, descriptions will be given by using the results of the shortest path searching process described with reference to FIG. 9A to FIG. 9P. Namely, it is assumed that the distance condition is “4”.

Regarding each of the nodes included in the first path group and the second path group, the feature graph generating unit 122 excludes the node in which the distance (or the tentative distance) from the starting point is set but the distance (or the tentative distance) from the end point is not set as out of target for the feature graph generating process. Similarly, regarding each of the nodes included in the first path group and the second path group, the feature graph generating unit 122 excludes the node in which the distance (or the tentative distance) from the end point is set but the distance (or the tentative distance) from the starting point is not set as out of target for the feature graph generating process. Furthermore, in the first path group, the nodes that are searched by the shortest path searching process and in each of which the distance or the tentative distance from the starting point is set are included. In the second path group, the nodes that are searched by the shortest path searching process and in each of which the distance or the tentative distance from the end point is set is included. Here, as illustrated in FIG. 10A, regarding the node 1, the node 2, and the node 4, the distance from the starting point is set but the distance from the end point is not set; therefore, these nodes are excluded as out of target for the feature graph generating process. This is because that a path does not reach from the end point node within the search condition.

Then, regarding each of the nodes included in both the first path group and the second path group, the feature graph generating unit 122 determines whether the sum of the distance of the first shortest path from the starting point node to a subject node and the distance of the second shortest path from the subject node to the end point node is less than or equal to the distance condition. Then, when the sum of the distance of the first shortest path from the starting point node to the subject node and the distance of the second shortest path from the subject node to the end point node is less than or equal to the distance condition, the feature graph generating unit 122 adds the path obtained by adding up the first shortest path and the second shortest path to the feature graph 25. Specifically, the feature graph generating unit 122 acquires the path associated with the target node from the starting point purpose table 22 and the end point purpose table 23, and then adds, regarding the edge within the acquired path, “O” to the target edge in the edge list 212. Furthermore, regarding the node within the path associated with the target node acquired from the starting point purpose table 22 and the end point purpose table 23, the feature graph generating unit 122 adds “O” to the target node in the node list 211.

Here, as illustrated in FIG. 10B, regarding the node 3, the feature graph generating unit 122 determines that the sum of the distance of the shortest path from the starting point node 1 to the node 3 and the distance of the shortest path from the node 3 to the end point node 10 is “3” and the distance condition is less than or equal to “4”. Thus, the feature graph generating unit 122 adds, to the feature graph 25, the path obtained by adding up the shortest path from the starting point node 1 to the node 3 and the shortest path from the node 3 to the end point node 10. Namely, the path obtained by adding up the shortest path of the starting point node 1→the node 3 and the shortest path of the node 3→the node 8 and the node 8→the end point node 10 is added to the feature graph 25. Specifically, the feature graph generating unit 122 acquires the path associated with the node 3 from the starting point purpose table 22 and the end point purpose table 23 and adds, regarding the edges [node1,node3], [node3,node8], and [node8,node10] included in the acquired path, “O” to the target edge in the edge list 212. Furthermore, regarding the node node1, the node3, the node8, and the node10 included in the path associated with the node 3 acquired from the starting point purpose table 22 and the end point purpose table 23, the feature graph generating unit 122 adds “O” to the target node in the node list 211.

Furthermore, as illustrated in FIG. 10C, regarding the node 5, the feature graph generating unit 122 determines that the sum of the distance of the shortest path from the starting point node 1 to the node 5 and the distance of the shortest path from the node 5 to the end point node 10 is “4” and the distance condition is less than or equal to “4”. Thus, the feature graph generating unit 122 adds, to the feature graph 25, the path obtained by adding up the shortest path from the starting point node 1 to the node 5 and the shortest path from the node 5 to the end point node 10. Namely, the path obtained by adding up the shortest path of the starting point node 1→the node 2→the node 5 and the shortest path of the node 5→the node 8→the end point node 10 is added to the feature graph 25. Specifically, the feature graph generating unit 122 acquires the path associated with the node 5 from the starting point purpose table 22 and the end point purpose table 23 and adds, regarding the edges [node1,node2], [node2,node5], [node5,node8], and [node8,node10] included in the acquired path, “O” to the target edge in the edge list 212. Furthermore, regarding the nodes of the node1, the node2, the node5, the node8, and the node10 included in the path associated with the node 5 acquired from the starting point purpose table 22 and the end point purpose table 23, the feature graph generating unit 122 adds “O” to the target node in the node list 211.

Furthermore, as illustrated in FIG. 10D, regarding the node 7, the feature graph generating unit 122 determines that the sum of the distance of the shortest path from the starting point node 1 to the node 7 and the distance of the shortest path from the node 7 to the end point node 10 is “4” and the distance condition is less than or equal to “4”. Thus, the feature graph generating unit 122 adds the path obtained by adding up the shortest path from the starting point node 1 to the node 7 and the shortest path from the node 7 to the end point node 10 to the feature graph 25. Namely, the path obtained by adding up the shortest path of the starting point node 1→the node 3→the node 7 and the shortest path of the node 7→the node 8→the end point node 10 is added to the feature graph 25. Specifically, the feature graph generating unit 122 acquires the path associated with the node 7 from the starting point purpose table 22 and the end point purpose table 23 and adds, regarding the edges [node1,node3], [node3,node7], [node7,node8], and [node8,node10] included in the acquired path, “O” to the target edge in the edge list 212. Furthermore, regarding the nodes of the node 1, the node 3, the node 7, the node 8, and the node 10 included in the path associated with the node 7 acquired from the starting point purpose table 22 and the end point purpose table 23, the feature graph generating unit 122 adds “O” to the target node in the node list 211.

Furthermore, as illustrated in FIG. 10E, regarding the node 6, the feature graph generating unit 122 determines that the sum of the distance of the shortest path from the starting point node 1 to the node 6 and the distance of the shortest path from the node 6 to the end point node 10 is “5” and is greater than the distance condition “4”. Thus, the feature graph generating unit 122 does not add, to the feature graph 25, the path obtained by adding up the shortest path from the starting point node 1 to the node 6 and the shortest path from the node 6 to the end point node 10.

Furthermore, as illustrated in FIG. 10F, regarding the node 8, the feature graph generating unit 122 determines that the sum of the distance of the shortest path from the starting point node 1 to the node 8 and the distance of the shortest path from the node 8 to the end point node 10 is “3” and the distance condition is less than or equal to “4”. Thus, the feature graph generating unit 122 adds, to the feature graph 25, the path obtained by adding up the shortest path from the starting point node 1 to the node 8 and the shortest path from the node 8 to the end point node 10. However, because the related nodes and the edges are already set in the node list 211 and the edge list 212, the feature graph generating unit 122 does not add the data to the node list 211 and the edge list 212.

Furthermore, as illustrated in FIG. 10G, regarding the node 9, the feature graph generating unit 122 determines that the sum of the distance of the shortest path from the starting point node 1 to the node 9 and the distance of the shortest path from the node 9 to the end point node 10 is “4” and the distance condition is less than or equal to “4”. Thus, the feature graph generating unit 122 adds, to the feature graph 25, the path obtained by adding up the shortest path from the starting point node 1 to the node 9 and the shortest path from the node 9 to the end point node 10. Namely, the path obtained by adding up the shortest path of the starting point node 1→the node 3→the node 7→the node 9 and the shortest path of the node 9→the end point node 10 is added to the feature graph 25. Specifically, the feature graph generating unit 122 acquires the path associated with the node 9 from the starting point purpose table 22 and the end point purpose table 23 and adds, regarding the edges [node1,node3], [node3,node7], [node7,node9], and [node9,node10] included in the acquired path, “O” to the target edge in the edge list 212. Furthermore, regarding the nodes of the node 1, the node 3, the node 7, the node 9, and the node 10 included in the path associated with the node 7 acquired from the starting point purpose table 22 and the end point purpose table 23, the feature graph generating unit 122 adds “O” to the target node in the node list 211.

Furthermore, as illustrated in FIG. 10H, regarding the node 10, the feature graph generating unit 122 determines that the sum of the distance of the shortest path from the starting point node 1 to the node 10 and the distance of the shortest path from the node 10 to the end point node 10 is “3” and the distance condition is less than or equal to “4”. Thus, the feature graph generating unit 122 adds, to the feature graph 25, the path obtained by adding up the shortest path from the starting point node 1 to the node 10 and the shortest path from the node 10 to the end point node 10. However, because the related nodes and edges are already set in the node list 211 and the edge list 212, the feature graph generating unit 122 does not add the data to the node list 211 and the edge list 212.

Then, if an unprocessed node in which the distance (or the tentative distance) from the starting point is set and the distance (or the tentative distance) from the end point is set is not present, the feature graph generating unit 122 ends the feature graph generating process. Here, the feature graph generating unit 122 ends the feature graph generating process because all of the nodes in which the distance (or the tentative distance) from the starting point is set and the distance (or the tentative distance) from the end point is set have been processed. The feature graph illustrated in FIG. 10I is the feature graph generated by the feature graph generating unit 122.

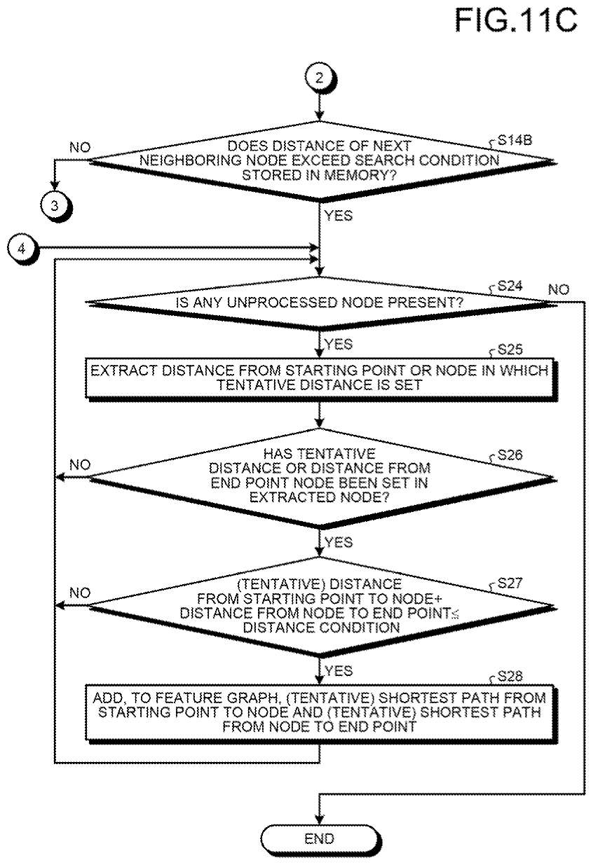

FIGS. 11A, 11B and 11C are flowcharts illustrating an example of the flow of the flow of the feature graph generating process according to the embodiment. Furthermore, in FIGS. 11A, 11B and 11C, a description will be given of the feature graph generating process performed when Dijkstra's algorithm is used as the shortest path search method. Furthermore, it is assumed that the starting point node and the end point node are designated by the learning unit 11 or the estimating unit 13. It is assumed that the search condition is not stored in the variable table 24 before the process is performed.

As illustrated in FIGS. 11A, 11B and 11C, the shortest path searching unit 121 obtains, by using Dijkstra's algorithm in the forward direction from the starting point node, the shortest path and the distance from the starting point node to the closest neighboring node (starting point node). In addition, the shortest path searching unit 121 obtains the tentative shortest path and the tentative distance from the starting point node to the adjacent node adjacent to the subject node. Then, the shortest path searching unit 121 stores each of the pieces of the obtained information in the starting point purpose table 22 in a memory (Step S11).

Then, the shortest path searching unit 121 obtains, by using Dijkstra's algorithm in the reverse direction from the end point node, the shortest path and the distance from the end point node to the closest neighboring node (end point node) that is the. In addition, the shortest path searching unit 121 obtains the tentative shortest path and the tentative distance from the end point node to the adjacent node adjacent to the subject node. Then, the shortest path searching unit 121 stores each of the pieces of the obtained information in the end point purpose table 23 in the memory (Step S12).

Then, the shortest path searching unit 121 determines whether the distance of the next neighboring node from the starting point node is less than or equal to the distance of the next neighboring node from the end point node (Step S13). When it is determined that the distance of the next neighboring node from the starting point node is less than or equal to the distance of the next neighboring node from the end point node (Yes at Step S13), the shortest path searching unit 121 performs the following process. Namely, the shortest path searching unit 121 determines whether the distance of the next neighboring node from the starting point exceeds the search condition stored in the memory (Step S14A).

When it is determined that the distance of the next neighboring node from the starting point does not exceed the search condition stored in the memory (No at Step S14A), the shortest path searching unit 121 performs the following process. Namely, the shortest path searching unit 121 obtains the shortest path and the distance from the starting point node to the second closest neighboring node. In addition, the shortest path searching unit 121 obtains the tentative shortest path and the tentative distance from the starting point node to the adjacent node adjacent to the subject node. Then, the shortest path searching unit 121 stores each of the pieces of the obtained information in the starting point purpose table 22 in the memory (Step S15).

Then, the shortest path searching unit 121 determines whether the search condition has been stored in the variable table 24 in the memory (Step S16). When it is determined that the search condition has been stored in the variable table 24 in the memory (Yes at Step S16), the shortest path searching unit 121 proceeds to Step S13 in order to perform the process on the next neighboring node.

In contrast, when it is determined that the search condition has not been stored in the variable table 24 in the memory (No at Step S16), the shortest path searching unit 121 performs the following process. Namely, the shortest path searching unit 121 determines whether the neighboring node stored immediately before in the starting point purpose table 22 in the memory has already been stored in the end point purpose table 23 in the memory as the neighboring node from the end point node (Step S17). When it is determined that the neighboring node stored immediately before in the starting point purpose table 22 in the memory has already been stored in the end point purpose table 23 in the memory as the neighboring node that is from the end point node (Yes at Step S17), the shortest path searching unit 121 proceeds to Step S21 in order to store the search condition. This is because that the shortest path from the starting point node to the end point node has been obtained.

In contrast, when it is determined that the neighboring node stored immediately before in the starting point purpose table 22 in the memory has not yet been stored in the end point purpose table 23 in the memory as the neighboring node that is from the end point node (No Step S17), the shortest path searching unit 121 proceeds to Step S13 in order to perform the process on the next neighboring node.

At Step S13, when it is determined that the distance of the next neighboring node from the starting point node is greater than the distance of the next neighboring node that is from the end point node (No at Step S13), the shortest path searching unit 121 proceeds to Step S14B in order to perform the process on the next neighboring node that is from the end point node.

At Step S14B, the shortest path searching unit 121 performs the following process. Namely, the shortest path searching unit 121 determines whether the distance of the next neighboring node that is from the end point exceeds the search condition stored in the memory (Step S14B).

When it is determined that the distance of the next neighboring node that is from the end point does not exceeds the search condition stored in the memory (No at Step S14B), the shortest path searching unit 121 performs the following process. Namely, the shortest path searching unit 121 obtains the shortest path and the distance from the end point node to the second closest neighboring node. In addition, the shortest path searching unit 121 obtains the tentative shortest path and the tentative distance from the end point node to the adjacent node adjacent to the subject node. Then, the shortest path searching unit 121 stores each of the pieces of the obtained information in the end point purpose table 23 in the memory (Step S18).

Then, the shortest path searching unit 121 determines whether the search condition has been stored in the variable table 24 in the memory (Step S19). When it is determined that the search condition has been stored in the variable table 24 in the memory (Yes at Step S19), the shortest path searching unit 121 proceeds to Step S13 in order to perform the process on the next neighboring node.

In contrast, when it is determined that the search condition is has not been stored in the variable table 24 in the memory (No at Step S19), the shortest path searching unit 121 performs the following process. Namely, the shortest path searching unit 121 determines whether the neighboring node stored immediately before in the end point purpose table 23 in the memory has already been stored in the starting point purpose table 22 in the memory as the neighboring node that is from the starting point node (Step S20). When it is determined that the neighboring node stored immediately before in the end point purpose table 23 in the memory has not yet been stored in the starting point purpose table 22 in the memory as the neighboring node that is from the starting point node (No at Step S20), the shortest path searching unit 121 proceeds to Step S13 in order to perform the process on the next neighboring node.

In contrast, when it is determined that the neighboring node that is stored immediately before in the end point purpose table 23 in the memory has already been stored in the starting point purpose table 22 in the memory as the neighboring node that is from the starting point node (Yes at Step S20), the shortest path searching unit 121 proceeds to Step S21 in order to store the search condition by using the neighboring node. This is because that, in this neighboring node, the shortest path from the starting point node to the end point node has been obtained.

At Step S21, the shortest path searching unit 121 obtains the sum of the distance from the starting point node to the neighboring node and the distance from the subject neighboring node to the end point node as the distance between the two points and stores the sum result in the variable table 24 in the memory (Step S21). In addition, the shortest path searching unit 121 stores the (distance between the two points+α)/2 as the search condition in the variable table 24 in the memory (Step S22). Furthermore, the shortest path searching unit 121 stores the (distance between the two points+a) as the distance condition in the variable table 24 in the memory (Step S23). Then, the shortest path searching unit 121 proceeds to Step S13 in order to perform the next neighboring node.

Here, when it is determined that the distance of the next neighboring node from the starting point exceeds the search condition stored in the memory (Yes at Step S14A), the shortest path searching unit 121 ends the shortest path searching process and proceeds to Step S24. Furthermore, when it is determined that the distance of the next neighboring node from the end point exceeds the search condition stored in the memory (Yes at Step S14B), the shortest path searching unit 121 ends the shortest path searching process and proceeds to Step S24.

At Step S24, the feature graph generating unit 122 determines whether an unprocessed node is present (Step S24). When it is determined that an unprocessed node is present (Yes at Step S24), the feature graph generating unit 122 extracts, from the starting point purpose table 22, the distance from the starting point node or the node in which a tentative distance is set (Step S25).

Then, the feature graph generating unit 122 determines whether, regarding the node that has been extracted (hereinafter, simply referred to as an extracted node), the tentative distance or the distance from the end point node has been set in the end point purpose table 23 (Step S26). When it is determined that, regarding the extracted node, the tentative distance or the distance from the end point node has not been set in the end point purpose table 23 (No at Step S26), the feature graph generating unit 122 proceeds to Step S24 in order to perform the process on the next node. This is because that the extracted node reaches as the result of conducting the shortest path search starting from the starting point node but does not reach as the result of conducting the shortest path search starting from the end point node.

In contrast, when it is determined that, regarding the extracted node, the tentative distance or the distance from the end point node has been set in the end point purpose table 23 (Yes at Step S26), the feature graph generating unit 122 performs the following process. Namely, the feature graph generating unit 122 determines whether the distance obtained by adding the distance (or the tentative distance) from the starting point node to the extracted node to the distance (or the tentative distance) from the extracted node to the end point node is less than or equal to the distance condition (Step S27).

When it is determined that the distance obtained by adding the distance (or the tentative distance) from the starting point node to the extracted node to the distance (or the tentative distance) from the extracted node to the end point node is not less than or equal to the distance condition (No at Step S27), the feature graph generating unit 122 proceeds to Step S24 in order to perform the process on the next node.

In contrast, when it is determined that the distance obtained by adding the distance (or the tentative distance) from the starting point node to the extracted node to the distance (or the tentative distance) from the extracted node to the end point node is less than or equal to the distance condition (Yes at Step S27), the feature graph generating unit 122 performs the following process. Namely, the feature graph generating unit 122 adds, to the feature graph, the shortest path (or the tentative shortest path) from the starting point node to the extracted node and the shortest path (or the tentative shortest path) from the extracted node to the end point node (Step S28). For example, the feature graph generating unit 122 acquires the path associated with the extracted node from the starting point purpose table 22 and the end point purpose table 23 and adds, regarding the edges included in the acquired path, “O” to the target edge in the edge list 212. Furthermore, regarding the node included in the path associated with the extracted node acquired from the starting point purpose table 22 and the end point purpose table 23, the feature graph generating unit 122 adds “O” to the target node in the node list 211. Then, the feature graph generating unit 122 proceeds to Step S24 in order to perform the process on the next node.

At Step S24, when it is determined that no unprocessed node is present (No at Step S24), the feature graph generating unit 122 ends the feature graph generating process.

According to the embodiment described above, when the information processing apparatus 1 generates a feature graph constructed by connecting the starting point node and the end point node selected from a plurality of nodes included in the directed graph, the information processing apparatus 1 specifies the first path group that is the result of the shortest path search conducted from the starting point node in the forward direction within the first distance and the second path group that is the result of the shortest path search conducted from the end point node in the reverse direction within the second distance. Then, regarding one of the nodes included in the first path group and the second path group, when the sum of the distance of the first shortest path from the starting point node to the one of the nodes and the distance of the second shortest path from the one of the nodes to the end point node is less than or equal to the distance obtained by adding a predetermined distance to the distance of the shortest path from the starting point node to the end point node, the information processing apparatus 1 generates the feature graph including the first shortest path and the second shortest path. With this configuration, when the information processing apparatus 1 generates the feature graph from the directed graph from a knowledge base, by using the distance of the shortest path that has been subjected to the shortest path search from the starting point node and the distance of the shortest path that has been subjected to the shortest path search from the end point node, it is possible to reduce an amount of calculation while ensuring the accuracy. Namely, when compared with the conventional technique for constructing a feature graph by listing all of the paths from the starting point node to the end point node less than or equal to the (distance of the shortest path+predetermined distance), the information processing apparatus 1 can reduce the amount of calculation while ensuring the accuracy.

Furthermore, according to the embodiment described above, the information processing apparatus 1 specifies the first path group that is the result of the shortest path search conducted from the starting point node in the forward direction within the first distance that is the distance obtained by adding a predetermined distance to the distance of the shortest path from the starting point node to the end point node. The information processing apparatus 1 specifies the second path group that is the result of the shortest path search conducted from the end point node in the reverse direction within the second distance that is the distance obtained by adding the predetermined distance to the distance of the shortest path from the starting point node to the end point node. With this configuration, by using the distance of the shortest path that is the result of the shortest path search conducted from each of the starting point node and the end point node within the distance obtained by adding the predetermined distance to the distance of the shortest path from the starting point node to the end point node, the information processing apparatus 1 can reduce an amount of calculation as compared with the conventional technique.

Furthermore, according to the embodiment described above, the information processing apparatus 1 specifies the first path group that is the result of the shortest path search conducted from the starting point node in the forward direction within a value greater than or equal to half of the value, as the first distance, obtained by adding the predetermined distance to the distance of the shortest path from the starting point node to the end point node. The information processing apparatus 1 specifies the second path group that is the result of the shortest path search conducted from the end point node in the reverse direction within a value greater than or equal to half of the value, as the second distance, obtained by adding the predetermined distance to the distance of the shortest path from the starting point node to the end point node. With this configuration, by using the distance of the shortest path that is the result of the shortest path search conducted from each of the starting point node and the end point node within the value greater than or equal to half of the value obtained by adding the predetermined distance to the distance of the shortest path from the starting point node to the end point node, the information processing apparatus 1 can reduce an amount of calculation as compared with the conventional technique.

Furthermore, according to the embodiment described above, the information processing apparatus 1 generates a machine learning model by performing machine learning using the generated feature graph. With this configuration, the information processing apparatus 1 can generate the machine learning model for learning the type of relationship between the starting point node and the end point node at high speed.

Furthermore, according to the embodiment described above, when the information processing apparatus 1 inputs the starting point node and the end point node of the estimation target, the information processing apparatus 1 inputs a feature graph that connects the starting point node and the end point node corresponding to the input estimation target to the machine learning model and estimates the relationship between the starting point node and the end point node corresponding to the estimation target. With this configuration, the information processing apparatus 1 can estimate the relationship between the starting point node and the end point node at high speed.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions. For example, the generating unit 12 may also be separated into the shortest path searching unit 121 and the feature graph generating unit 122. Furthermore, the shortest path searching unit 121 may also be separated into a first shortest path searching unit that conducts the shortest path search from the starting point node and a second shortest path searching unit that conducts the shortest path search from the end point node. Furthermore, the storage unit 20 may also be connected as an external device of the information processing apparatus 1 via a network.

Furthermore, in the embodiment described above, a description has been given of a case in which the information processing apparatus 1 conducts the shortest path search by using Dijkstra's algorithm within the (distance of the shortest path+α)×½ starting from each of the starting point node and the end point node. However, the information processing apparatus 1 is not limited to this and may also conduct the shortest path search by using Dijkstra's algorithm within the (distance of the shortest path+α)×⅔ from each of the starting point node and the end point node. Furthermore, the information processing apparatus 1 may also conduct the shortest path search by using Dijkstra's algorithm within the (distance of the shortest path+α)×¾ from each of the starting point node and the end point node. Namely, any distance can be used for the shortest path search as long as the information processing apparatus 1 conducts the shortest path search by using Dijkstra's algorithm within the (distance of the shortest path+α)×(½+β) (β: a positive number) from each of the starting point node and the end point node.

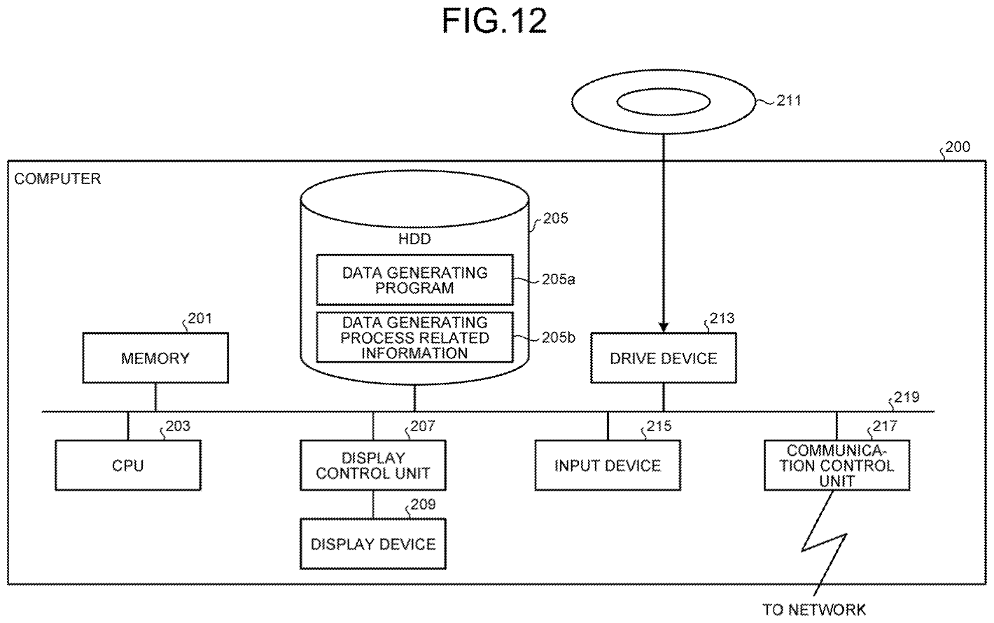

Furthermore, various kinds of processes described in the above embodiments can be implemented by executing programs prepared in advance in a computer system, such as a personal computer, a workstation, or the like. Thus, in the following, an example of a computer that executes a data generating program that implements the same function as that performed by the information processing apparatus 1 illustrated in FIG. 1 will be described. FIG. 12 is a diagram illustrating an example of a computer that executes a data generating program.

As illustrated in FIG. 12, a computer 200 includes a CPU 203 that executes various kinds of arithmetic processing, an input device 215 that receives an input of data from a user, and a display control unit 207 that controls a display device 209. Furthermore, the computer 200 includes a drive device 213 that reads programs or the like from a storage medium and a communication control unit 217 that sends and receives data to and from another computer via the network. Furthermore, the computer 200 includes a memory 201 that temporarily stores therein various kinds of information and a hard disk drive (HDD) 205. Then, the memory 201, the CPU 203, the HDD 205, the display control unit 207, the drive device 213, the input device 215, and the communication control unit 217 are connected by a bus 219.

The drive device 213 is a device for, for example, a removable disk 210. The HDD 205 stores therein a data generating program 205a and data generating process related information 205b.

The CPU 203 reads the data generating program 205a, loads the program in the memory 201, and executes the program as a process. The process corresponds to each of the functioning units included in the information processing apparatus 1. The data generating process related information 205b corresponds to the knowledge base 21, the starting point purpose table 22, the end point purpose table 23, the variable table, the feature graph 25, and the machine learning model 26. Then, for example, the removable disk 210 stores therein each of the pieces of information, such as the data generating program 205a.

Furthermore, the data generating program 205a is not always stored in the HDD 205 from the beginning. For example, the program is stored in a “portable physical medium”, such as a flexible disk (FD), a CD-ROM, a DVD disk, a magneto-optic disk, an IC CARD, or the like, that is to be inserted into the computer 200. Then, the computer 200 may also read and execute the data generating program 205a from the portable physical medium.

According to an aspect of an embodiment, when a feature graph is generated from the knowledge base, it is possible to reduce calculation load while ensuring the accuracy.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein instructions executable by one or more computer, the instructions comprising:
one or instructions for identifying a first path group by a shortest path search conducted from a start point node in a forward direction within a first distance, the start point node being included in a plurality of nodes in a directed graph;
one or instructions for identifying a second path group by another shortest path search conducted from an end point node in a reverse direction within a second distance, the end point node being included in the plurality of nodes; and
one or instructions for generating, when sum of a distance of a first shortest path between the start point node and a first node included in the first path group and a distance of a second shortest path between the end point node and a second node included in the second path group is not more than a threshold obtained by adding a specific distance to a distance of a shortest path between the start point node and the end point node, a feature graph including the first shortest path and the second shortest path.

2. The non-transitory computer-readable recording medium according to claim 1, wherein each of the first distance and the second distance is equal to the threshold.

3. The non-transitory computer-readable recording medium according to claim 1, wherein each of the first distance and the second distance is a value greater than or equal to half of the threshold.

4. The non-transitory computer-readable recording medium according to claim 1, the instructions further comprising:
one or instructions for generating a machine learning model by machine learning based on the generated feature graph.

5. The non-transitory computer-readable recording medium according to claim 4, the instructions further comprising:
one or instructions for inputting, when receiving designation of a start node and an end node as an estimation target, a feature graph that connects the start node and the end node to the machine learning model; and
one or instructions for estimating a relationship between the start node and the end node.

6. A computing system comprising:
a memory; and
a processor coupled to the memory and the processor configured to:
identify a first path group by a shortest path search conducted from a start point node in a forward direction within a first distance, the start point node being included in a plurality of nodes in a directed graph;
identify a second path group by another shortest path search conducted from an end point node in a reverse direction within a second distance, the end point node being included in the plurality of nodes; and
generate, when sum of a distance of a first shortest path between the start point node and a first node included in the first path group and a distance of a second shortest path between the end point node and a second node included in the second path group is not more than a threshold obtained by adding a specific distance to a distance of a shortest path between the start point node and the end point node, a feature graph including the first shortest path and the second shortest path.

7. The computing system according to claim 6, wherein each of the first distance and the second distance is equal to the threshold.

8. The computing system according to claim 6, wherein each of the first distance and the second distance is a value greater than or equal to half of the threshold.

9. The computing system according to claim 6, the processor further configured to generate a machine learning model by machine learning based on the generated feature graph.

10. The computing system according to claim 9, the processor further configured to
input, when receiving designation of a start node and an end node as an estimation target, a feature graph that connects the start node and the end node to the machine learning model; and
estimate a relationship between the start node and the end node.

11. A computer-implemented data generating method comprising:
identifying a first path group by a shortest path search conducted from a start point node in a forward direction within a first distance, the start point node being included in a plurality of nodes in a directed graph using a processor;
identifying a second path group by another shortest path search conducted from an end point node in a reverse direction within a second distance, the end point node being included in the plurality of nodes using the processor;
generating, when sum of a distance of a first shortest path between the start point node and a first node included in the first path group and a distance of a second shortest path between the end point node and a second node included in the second path group is not more than a threshold obtained by adding a specific distance to a distance of a shortest path between the start point node and the end point node, a feature graph including the first shortest path and the second shortest path using the processor.
